(19) United States
(12) Patent Application Publication
(10) Pub. No.: US 2020/0379635 A1
(43) Pub. Date: Dec. 3, 2020

(54) USER INTERFACES WITH INCREASED VISIBILITY

(71) Applicant: Apple Inc., Cupertino, CA (US)

(72) Inventors: Gregory F. HUGHES, San Jose, CA (US); Chia-Hao CHEN, San Jose, CA (US)

(21) Appl. No.: 16/822,591

(22) Filed: Mar. 18, 2020

Related U.S. Application Data
(60) Provisional application No. 62/856,017, filed on Jun. 1, 2019.

(51) Int. Cl. G06F 3/0484; G06F 3/0481

(52) U.S. Cl. CPC G06F 3/04847; G06F 3/0481

(57) ABSTRACT

The present disclosure generally relates to enlarging user interface elements. An example method includes displaying a first version of first content; while displaying the first version of first content, displaying a focus indicator at a first location that does not correspond to the first version of first content; receiving first input; in response to receiving the first input, moving the focus indicator to a second location; in accordance with the second location corresponding to the first version and a set of second version display criteria being met, concurrently displaying at least a portion of the first version of first content and a second version of first content, wherein the second version differs from the first version in a visual characteristic other than size; and in accordance with the second location not corresponding to the first version of first content, forgoing display of the second version of first content.

### CROSS-REFERENCE TO RELATED APPLICATIONS

This application claims priority to U.S. Provisional Patent Application Ser. No. 62/856,017, titled “USER INTERFACES WITH INCREASED VISIBILITY,” filed on Jun. 1, 2019, the content of which is hereby incorporated by reference in its entirety.

### FIELD

The present disclosure relates generally to computer user interfaces, and more specifically to user interfaces with increased visibility.

### BACKGROUND

Users of personal electronic devices are more frequently using devices to complete tasks. While completing tasks, users often view highly-dense information. Some existing techniques allowed users to enlarge user interface elements.

### BRIEF SUMMARY

Some techniques for increasing the visibility of user interface elements using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for increasing the visibility of user interface elements. Such methods and interfaces optionally complement or replace other methods for increasing the visibility of user interface elements. Such methods and interfaces reduce the cognitive burden on a user and produce a more efficient human-machine interface. For battery-operated computing devices, such methods and interfaces conserve power and increase the time between battery charges.

In accordance with some embodiments, a method is described. In some embodiments, a method is perform at an electronic device with a display device. In some embodiments, the method comprises: displaying, via the display device, a first version of a first content; while displaying the first version of the first content, displaying, via the display device, a focus indicator at a first location that does not correspond to the first version of the first content; receiving a first input; in response to receiving the first input, moving the focus indicator from the first location to a second location; and in accordance with the second location corresponding to the first version of the first content and a set of second version display criteria being met, concurrently displaying, via the display device: at least a portion of the first version of the first content; and a second version of the first content, where the second version differs from the first version in a visual characteristic other than size; and in accordance with the second location not corresponding to the first version of the first content, forgoing display of the second version of the first content.

In accordance with some embodiments, a non-transitory computer-readable storage medium is described. In some embodiments, the non-transitory computer-readable storage medium stores one or more programs configured to be executed by one or more processors of an electronic device with a display device, the one or more programs including instructions for: displaying, via the display device, a first version of a first content; while displaying the first version of the first content, displaying, via the display device, a focus indicator at a first location that does not correspond to the first version of the first content; receiving a first input; in response to receiving the first input, moving the focus indicator from the first location to a second location; and in accordance with the second location corresponding to the first version of the first content and a set of second version display criteria being met, concurrently displaying, via the display device: at least a portion of the first version of the first content; and a second version of the first content, where the second version differs from the first version in a visual characteristic other than size; and in accordance with the second location not corresponding to the first version of the first content, forgoing display of the second version of the first content.

In accordance with some embodiments, a transitory computer-readable storage medium is described. In some embodiments, the transitory computer-readable storage medium stores one or more programs configured to be executed by one or more processors of an electronic device with a display device, the one or more programs including instructions for: displaying, via the display device, a first version of a first content; while displaying the first version of the first content, displaying, via the display device, a focus indicator at a first location that does not correspond to the first version of the first content; receiving a first input; in response to receiving the first input, moving the focus indicator from the first location to a second location; and in accordance with the second location corresponding to the first version of the first content and a set of second version display criteria being met, concurrently displaying, via the display device: at least a portion of the first version of the first content; and a second version of the first content, where the second version differs from the first version in a visual characteristic other than size; and in accordance with the second location not corresponding to the first version of the first content, forgoing display of the second version of the first content.

In accordance with some embodiments, an electronic device is described. In some embodiments, the electronic device includes: a display device; one or more processors; and memory storing one or more programs configured to be executed by the one or more processors, the one or more programs including instructions for: displaying, via the display device, a first version of a first content; while displaying the first version of the first content, displaying, via the display device, a focus indicator at a first location that does not correspond to the first version of the first content; receiving a first input; in response to receiving the first input, moving the focus indicator from the first location to a second location; and in accordance with the second location corresponding to the first version of the first content and a set of second version display criteria being met, concurrently displaying, via the display device: at least a portion of the first version of the first content; and a second version of the first content, where the second version differs from the first version in a visual characteristic other than size; and in accordance with the second location not corresponding to the first version of the first content, forgoing display of the second version of the first content.

In accordance with some embodiments, an electronic device is described. In some embodiments, the electronic device includes: a display device; means for displaying, via the display device, a first version of a first content; means, while displaying the first version of the first content, for displaying, via the display device, a focus indicator at a first location that does not correspond to the first version of the first content; means for receiving a first input; means, responsive to receiving the first input, for moving the focus indicator from the first location to a second location; and means, in accordance with the second location corresponding to the first version of the first content and a set of second version display criteria being met, for concurrently displaying, via the display device: at least a portion of the first version of the first content; and a second version of the first content, where the second version differs from the first version in a visual characteristic other than size; and means, in accordance with the second location not corresponding to the first version of the first content, for forgoing display of the second version of the first content.

In accordance with some embodiments, a method is described. In some embodiments, a method is perform at an electronic device with a display device and one or more input devices, including a pointing device. In some embodiments, the method comprises: concurrently displaying, via the display device: a first visible portion of a first user interface that includes a plurality of content segments, including a first content segment, where the first visible portion includes the first content segment; and a focus indicator, that is moveable via the pointing device; while the focus indicator is at a first position corresponding to the first content segment and while the first user interface is configured to receive indicator-based inputs, receiving a first set of one or more inputs; in response to receiving the first set of one or more inputs: displaying, via the display device, a second user interface over at least a first sub-portion of the first visible portion of the first user interface, the second user interface including a first visible content that corresponds to at least a portion of the first content segment; maintaining display of at least a second sub-portion of the first visible portion of the first user interface; and configuring the second user interface to receive indicator-based inputs; while the second user interface is configured to receive indicator-based inputs, receiving a second set of one or more inputs corresponding to a request to scroll content; and in response to receiving the second set of one or more inputs: in accordance with a determination that first scrolling criteria are met, scrolling the second user interface by replacing the first visible content with a second visible content; and in accordance with a determination that second scrolling criteria are met: scrolling the second user interface by replacing the first visible content with a third visible content; and scrolling the first user interface by replacing the first visible portion with a second visible portion.

In accordance with some embodiments, a non-transitory computer-readable storage medium is described. In some embodiments, the non-transitory computer-readable storage medium storing one or more programs configured to be executed by one or more processors of an electronic device with a display device and one or more input devices, including a pointing device, the one or more programs including instructions for: concurrently displaying, via the display device: a first visible portion of a first user interface that includes a plurality of content segments, including a first content segment, where the first visible portion includes the first content segment; and a focus indicator, that is moveable via the pointing device; while the focus indicator is at a first position corresponding to the first content segment and while the first user interface is configured to receive indicator-based inputs, receiving a first set of one or more inputs; in response to receiving the first set of one or more inputs: displaying, via the display device, a second user interface over at least a first sub-portion of the first visible portion of the first user interface, the second user interface including a first visible content that corresponds to at least a portion of the first content segment; maintaining display of at least a second sub-portion of the first visible portion of the first user interface; and configuring the second user interface to receive indicator-based inputs; while the second user interface is configured to receive indicator-based inputs, receiving a second set of one or more inputs corresponding to a request to scroll content; and in response to receiving the second set of one or more inputs: in accordance with a determination that first scrolling criteria are met, scrolling the second user interface by replacing the first visible content with a second visible content; and in accordance with a determination that second scrolling criteria are met: scrolling the second user interface by replacing the first visible content with a third visible content; and scrolling the first user interface by replacing the first visible portion with a second visible portion.

In accordance with some embodiments, a transitory computer-readable storage medium is described. In some embodiments, the transitory computer-readable storage medium storing one or more programs configured to be executed by one or more processors of an electronic device with a display device and one or more input devices, including a pointing device, the one or more programs including instructions for: concurrently displaying, via the display device: a first visible portion of a first user interface that includes a plurality of content segments, including a first content segment, where the first visible portion includes the first content segment; and a focus indicator, that is moveable via the pointing device; while the focus indicator is at a first position corresponding to the first content segment and while the first user interface is configured to receive indicator-based inputs, receiving a first set of one or more inputs; in response to receiving the first set of one or more inputs: displaying, via the display device, a second user interface over at least a first sub-portion of the first visible portion of the first user interface, the second user interface including a first visible content that corresponds to at least a portion of the first content segment; maintaining display of at least a second sub-portion of the first visible portion of the first user interface; and configuring the second user interface to receive indicator-based inputs; while the second user interface is configured to receive indicator-based inputs, receiving a second set of one or more inputs corresponding to a request to scroll content; and in response to receiving the second set of one or more inputs: in accordance with a determination that first scrolling criteria are met, scrolling the second user interface by replacing the first visible content with a second visible content; and in accordance with a determination that second scrolling criteria are met: scrolling the second user interface by replacing the first visible content with a third visible content; and scrolling the first user interface by replacing the first visible portion with a second visible portion.

In accordance with some embodiments, an electronic device is described. In some embodiments, the electronic device includes: a display device; one or more input devices, including a pointing device; one or more processors; and memory storing one or more programs configured to be executed by the one or more processors, the one or more programs including instructions for: concurrently displaying, via the display device: a first visible portion of a first user interface that includes a plurality of content segments, including a first content segment, where the first visible portion includes the first content segment; and a focus indicator, that is moveable via the pointing device; while the focus indicator is at a first position corresponding to the first content segment and while the first user interface is configured to receive indicator-based inputs, receiving a first set of one or more inputs; in response to receiving the first set of one or more inputs: displaying, via the display device, a second user interface over at least a first sub-portion of the first visible portion of the first user interface, the second user interface including a first visible content that corresponds to at least a portion of the first content segment; maintaining display of at least a second sub-portion of the first visible portion of the first user interface; and configuring the second user interface to receive indicator-based inputs; while the second user interface is configured to receive indicator-based inputs, receiving a second set of one or more inputs corresponding to a request to scroll content; and in response to receiving the second set of one or more inputs: in accordance with a determination that first scrolling criteria are met, scrolling the second user interface by replacing the first visible content with a second visible content; and in accordance with a determination that second scrolling criteria are met: scrolling the second user interface by replacing the first visible content with a third visible content; and scrolling the first user interface by replacing the first visible portion with a second visible portion.

In accordance with some embodiments, an electronic device is described. In some embodiments, the electronic device includes: a display device; one or more input devices, including a pointing device; means for concurrently displaying, via the display device: a first visible portion of a first user interface that includes a plurality of content segments, including a first content segment, where the first visible portion includes the first content segment; and a focus indicator, that is moveable via the pointing device; means, while the focus indicator is at a first position corresponding to the first content segment and while the first user interface is configured to receive indicator-based inputs, for receiving a first set of one or more inputs; means, responsive to receiving the first set of one or more inputs, for: displaying, via the display device, a second user interface over at least a first sub-portion of the first visible portion of the first user interface, the second user interface including a first visible content that corresponds to at least a portion of the first content segment; maintaining display of at least a second sub-portion of the first visible portion of the first user interface; and configuring the second user interface to receive indicator-based inputs; means, while the second user interface is configured to receive indicator-based inputs, for receiving a second set of one or more inputs corresponding to a request to scroll content; and means, responsive to receiving the second set of one or more inputs, for: in accordance with a determination that first scrolling criteria are met, scrolling the second user interface by replacing the first visible content with a second visible content; and in accordance with a determination that second scrolling criteria are met: scrolling the second user interface by replacing the first visible content with a third visible content; and scrolling the first user interface by replacing the first visible portion with a second visible portion.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for increasing the visibility of user interface elements, thereby increasing the effectiveness, efficiency, and user satisfaction with such devices. Such methods and interfaces may complement or replace other methods for increasing the visibility of user interface elements.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AD illustrate exemplary user interfaces for increasing the visibility of user interface elements, in accordance with some embodiments.

FIGS. 7A-7C illustrate a flow diagram of a method for increasing the visibility of user interface elements, in accordance with some embodiments.

FIGS. 8A-8C illustrate a flow diagram of a method for increasing the visibility of user interface elements, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for increasing the visibility of user interface elements. User may need to enlarge user interface elements when completing tasks using the electronic device, for instance, when one or more elements of a user interface are hard to see or utilize due to size of the elements. Such techniques can reduce the cognitive burden on a user who views user interface elements, thereby enhancing productivity. Further, such techniques can reduce processor and battery power otherwise wasted on redundant user inputs.

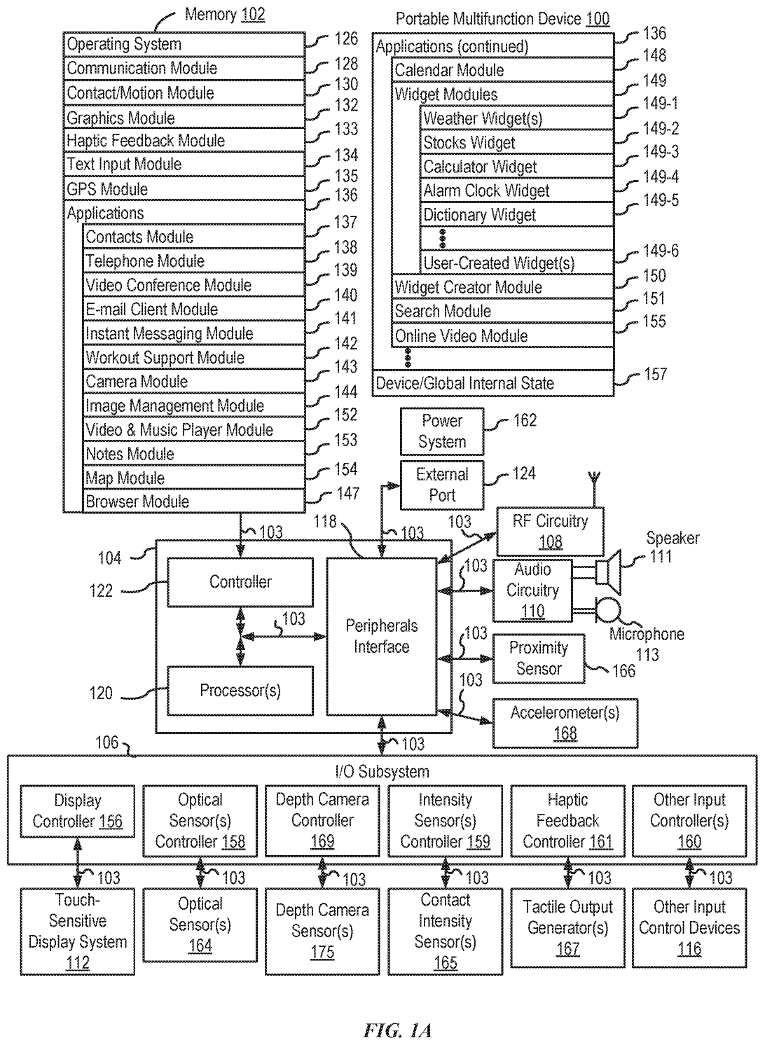

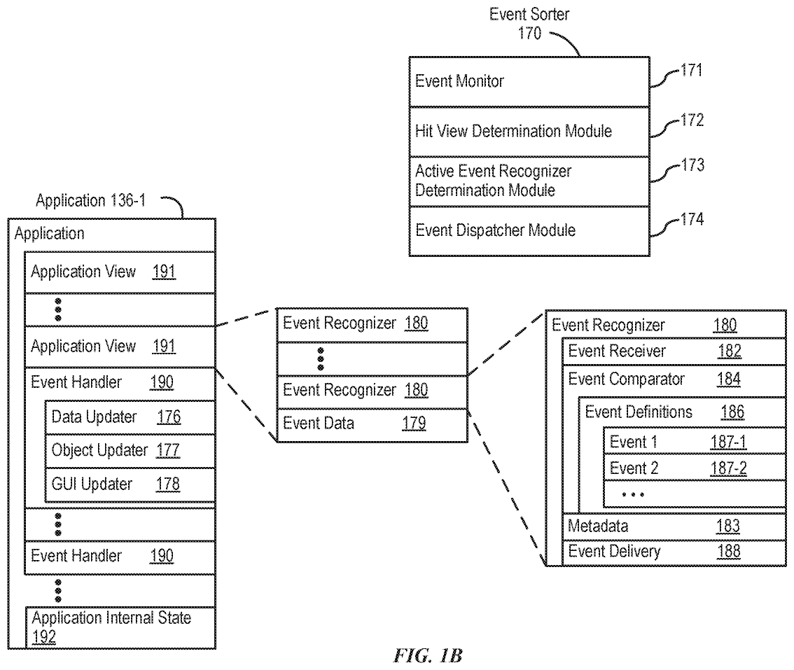

Below, FIGS. 1A-1B, 2, 3, 4A-4B, and 5A-5B provide a description of exemplary devices for performing the techniques for managing event notifications.

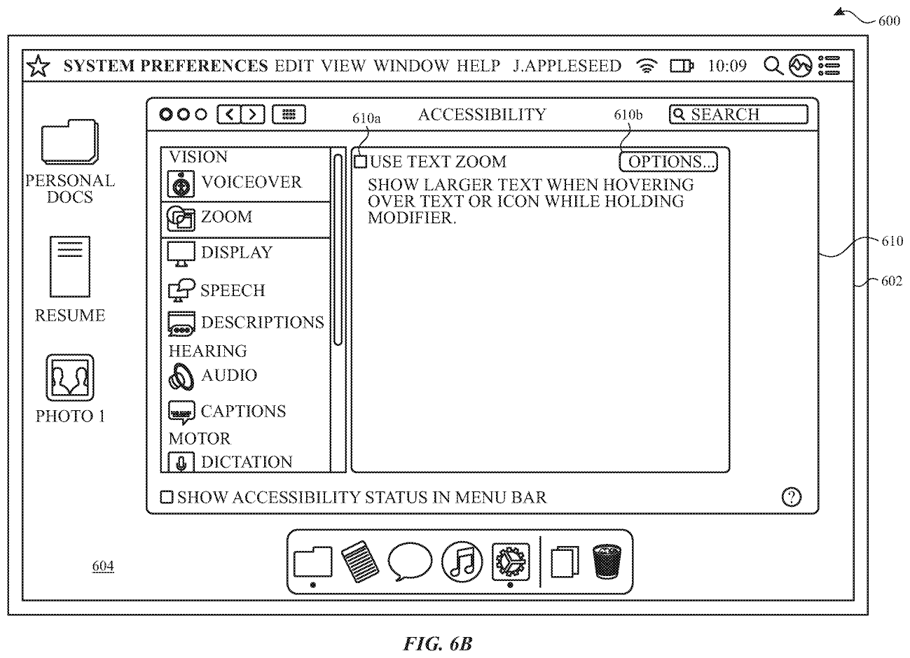

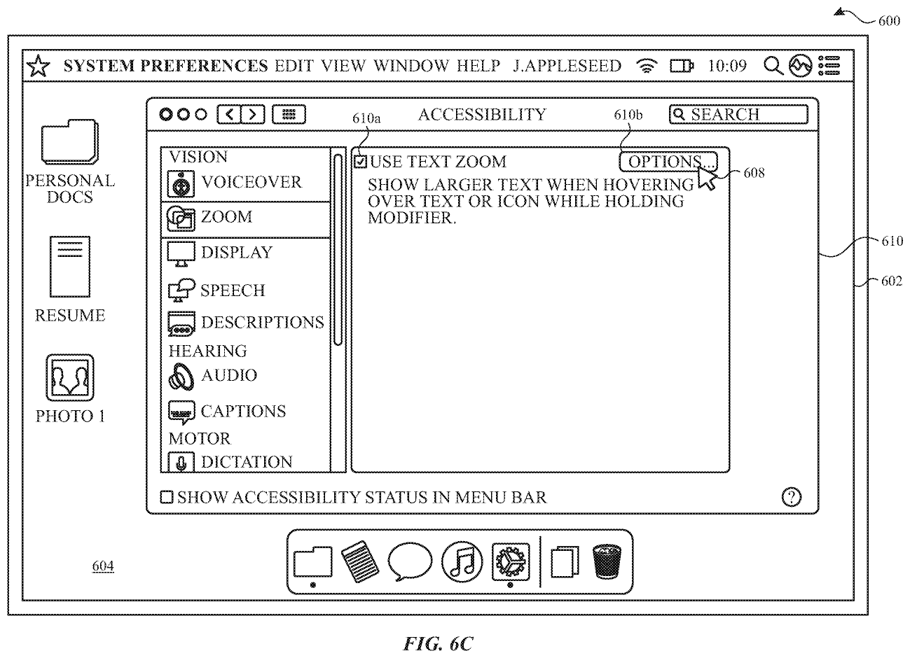

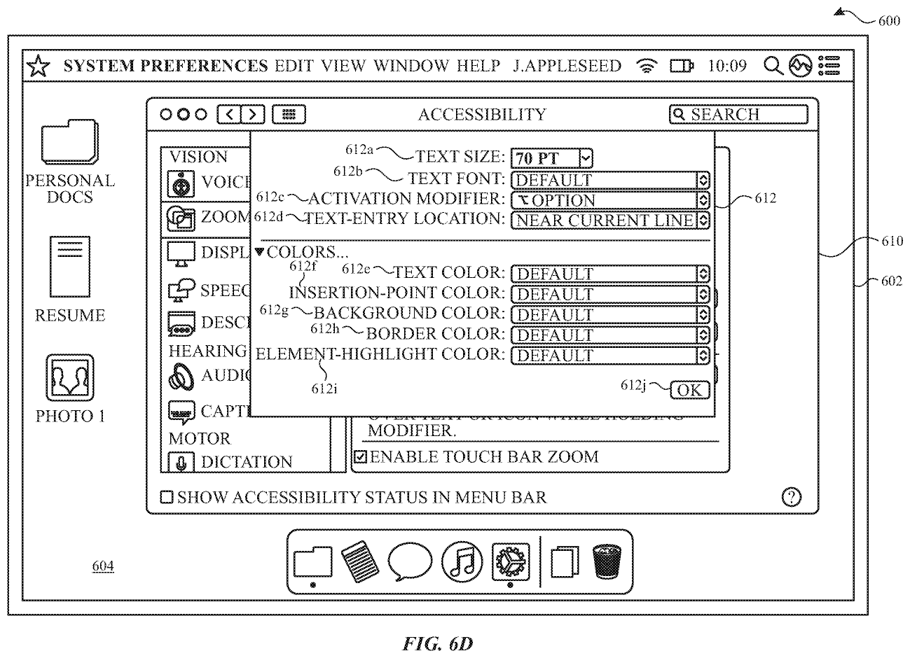

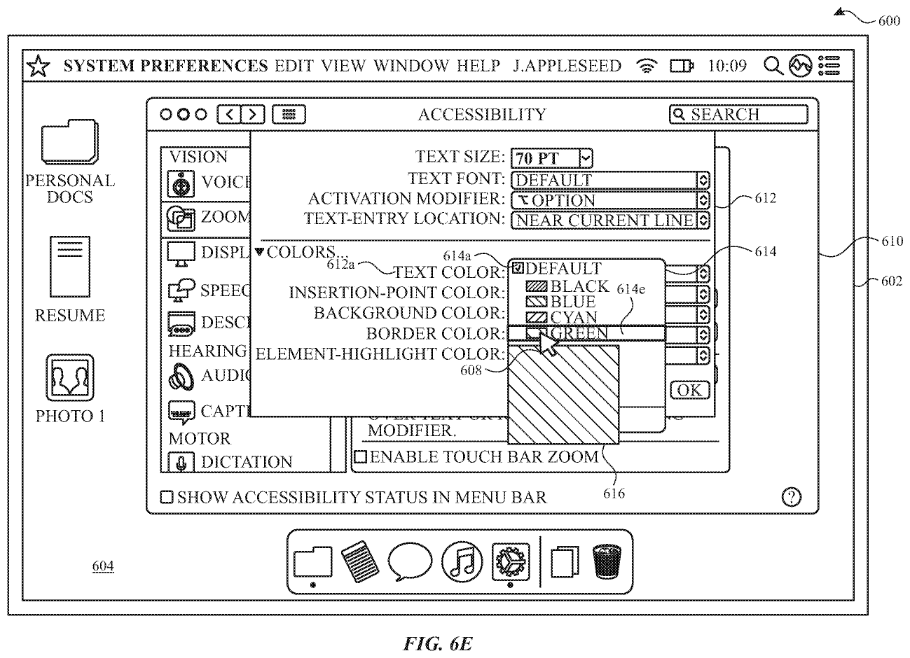

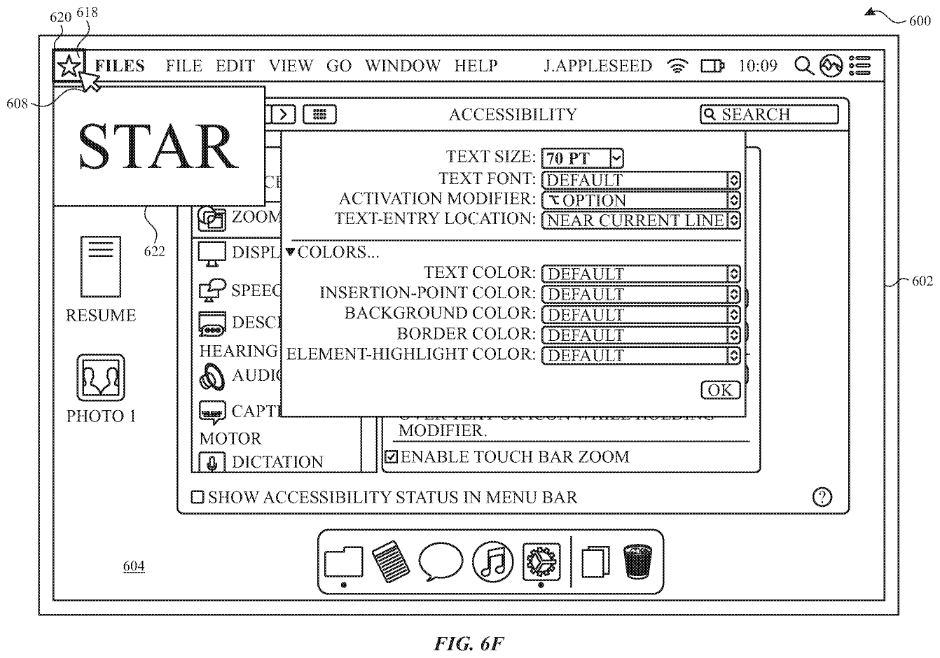

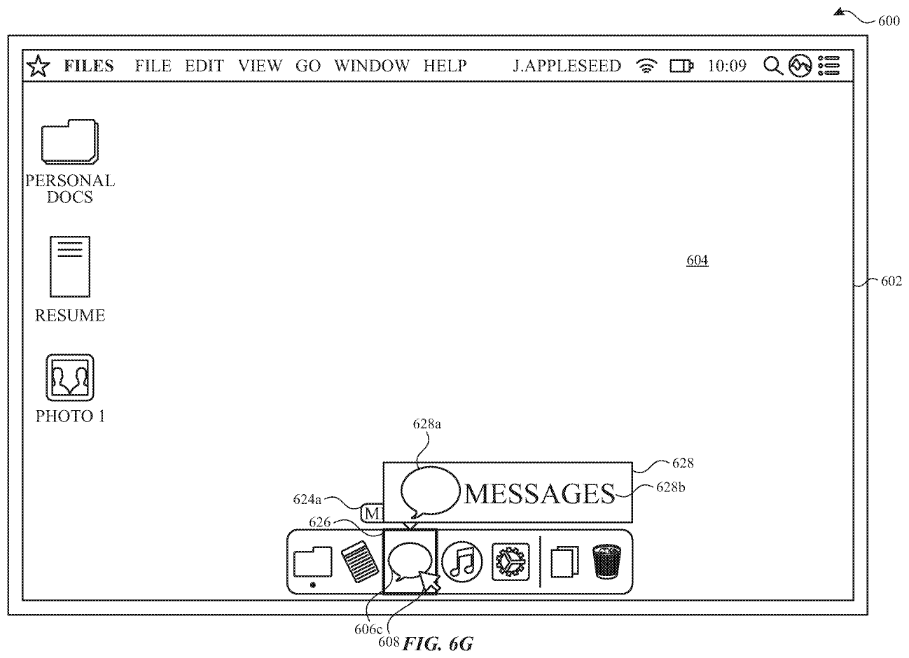

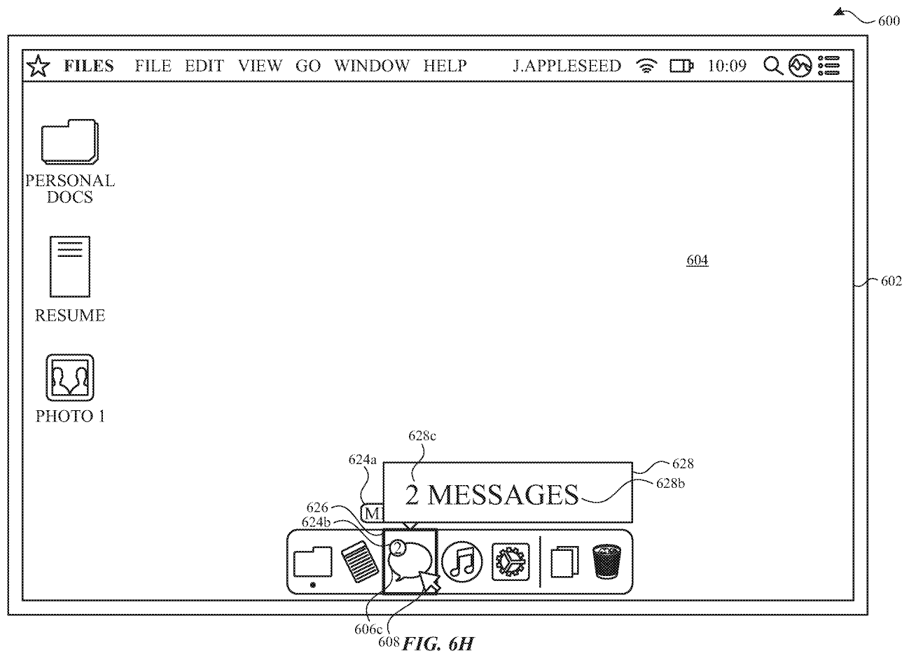

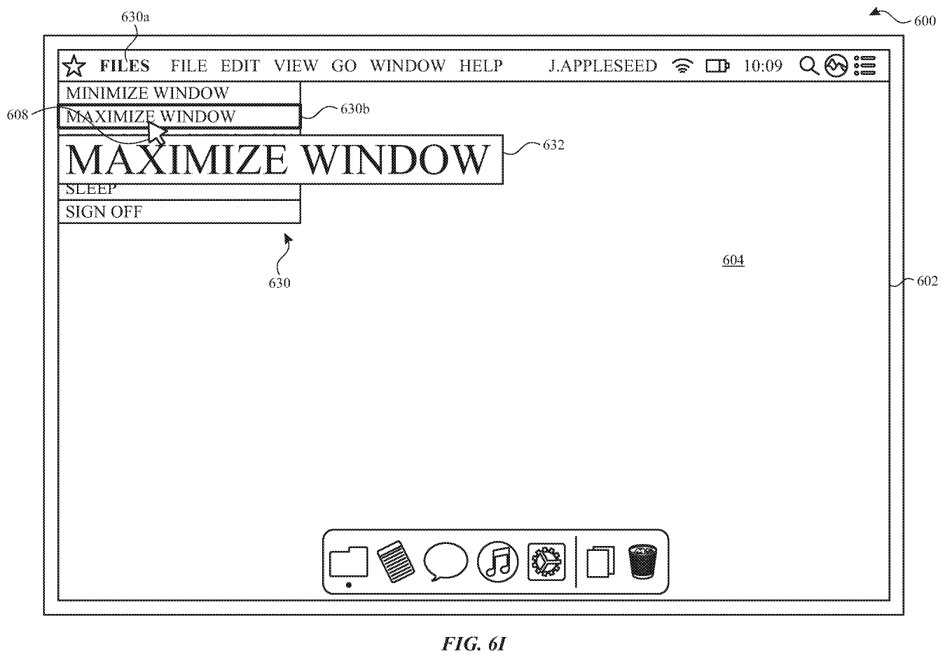

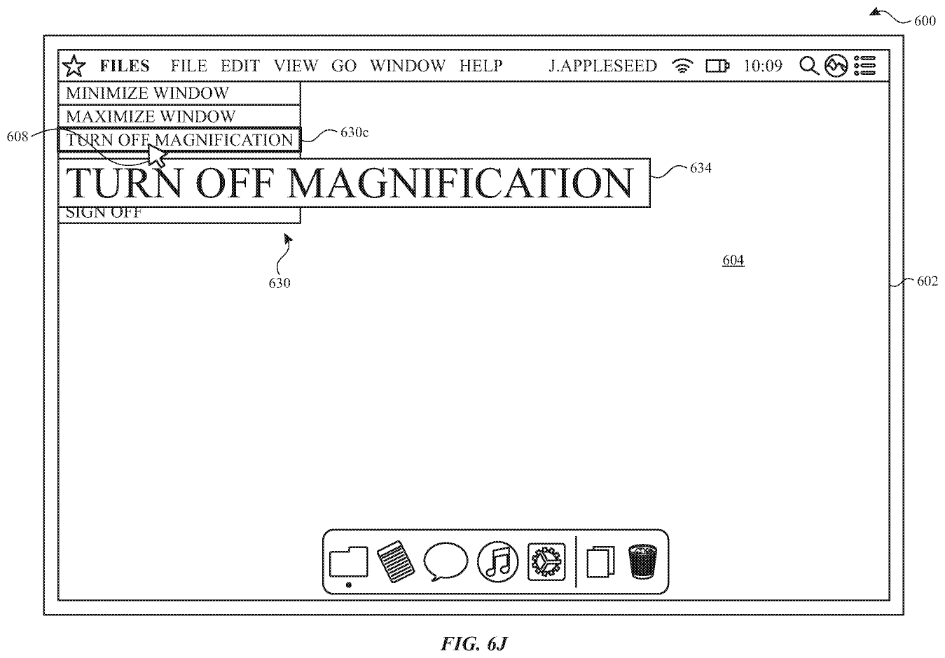

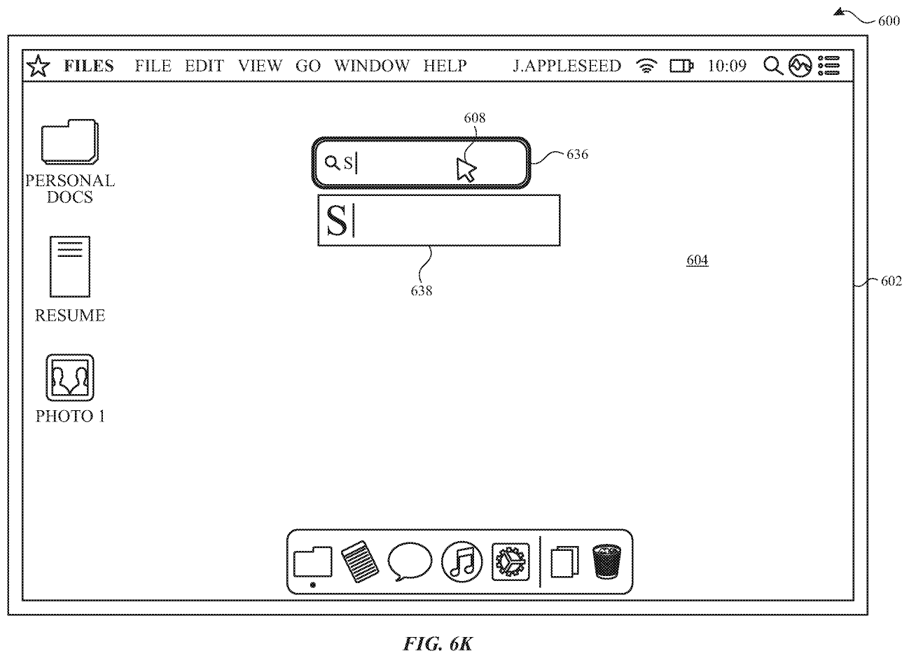

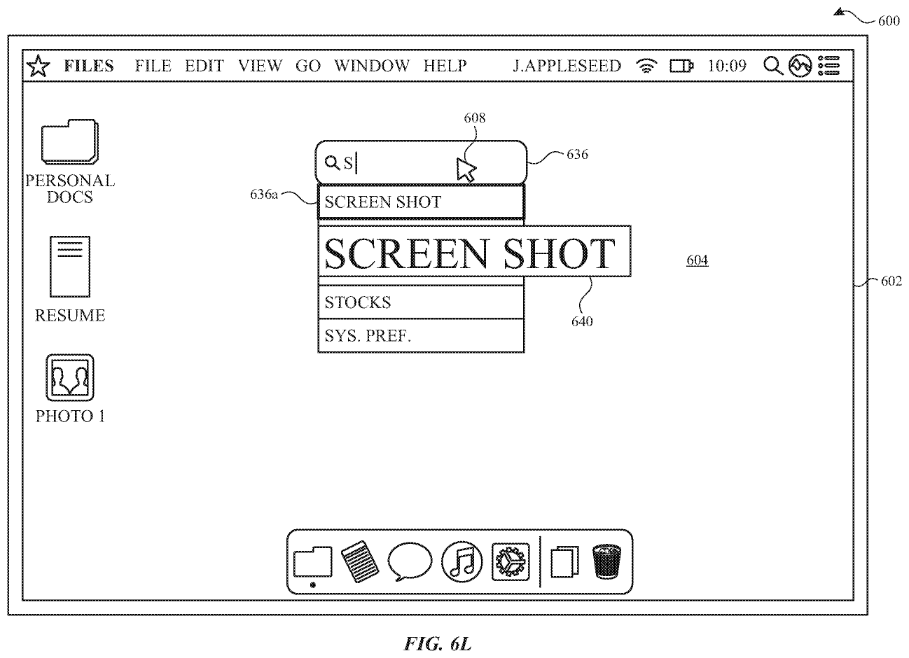

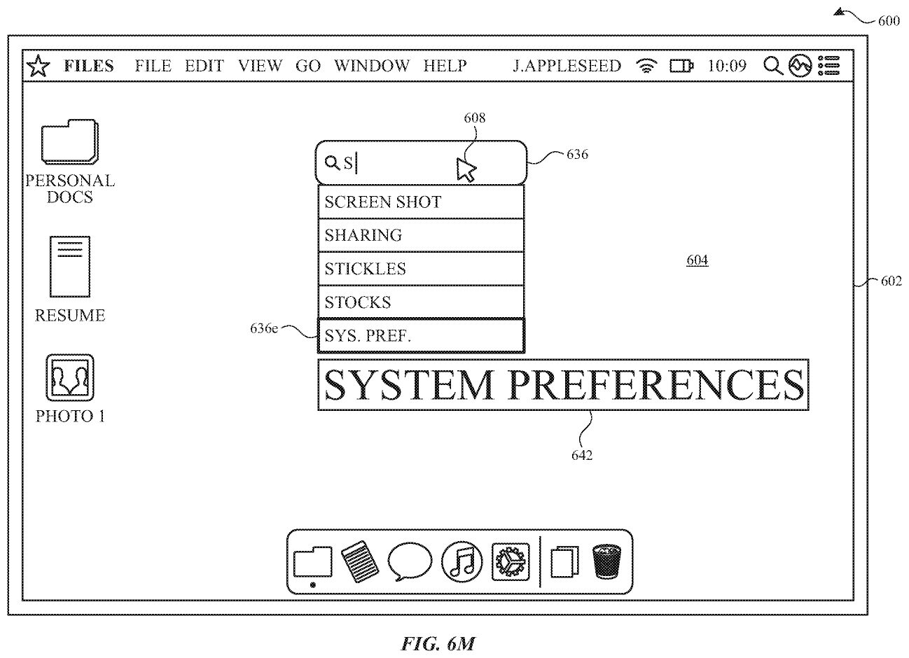

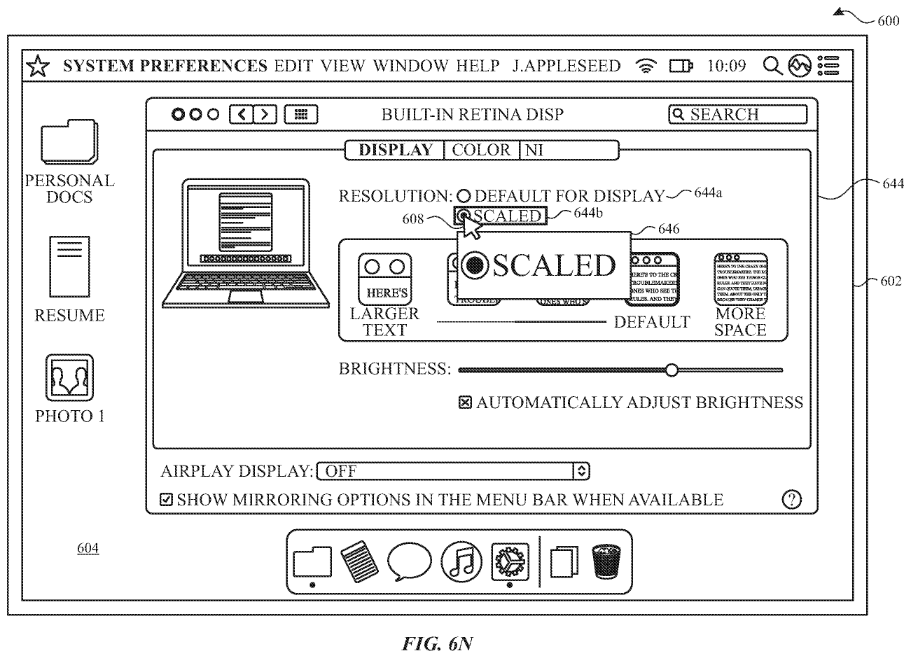

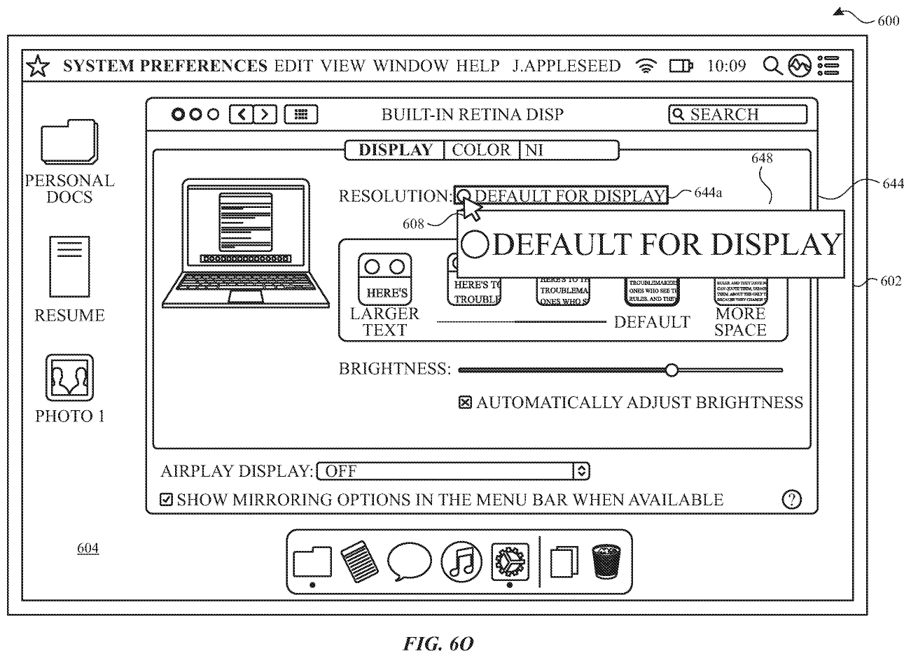

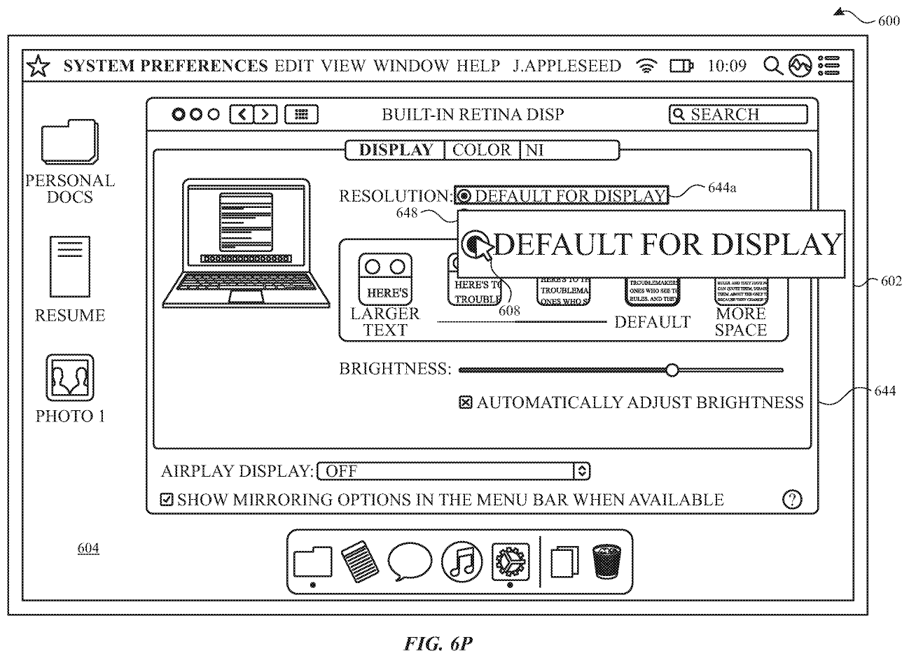

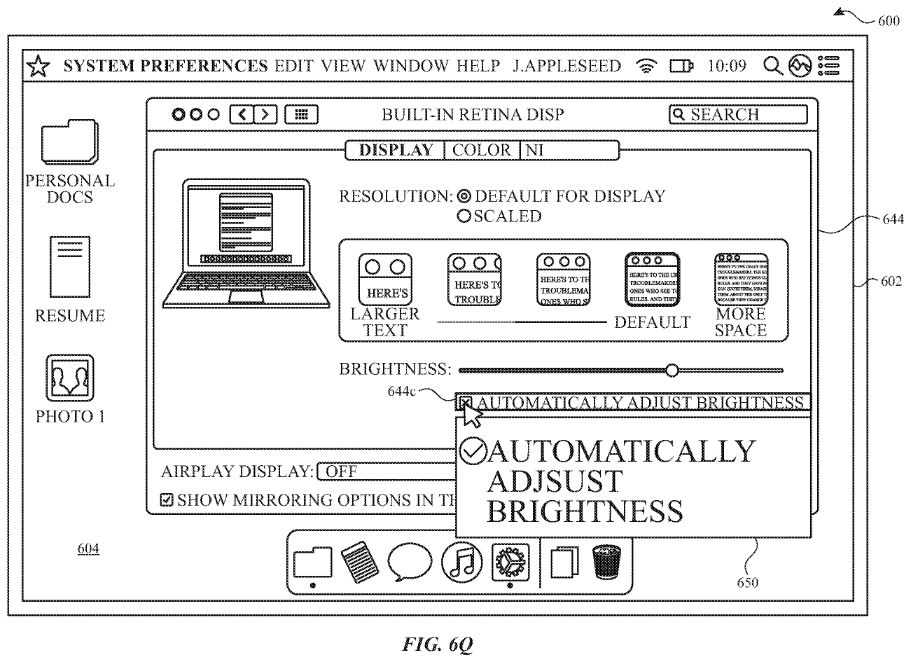

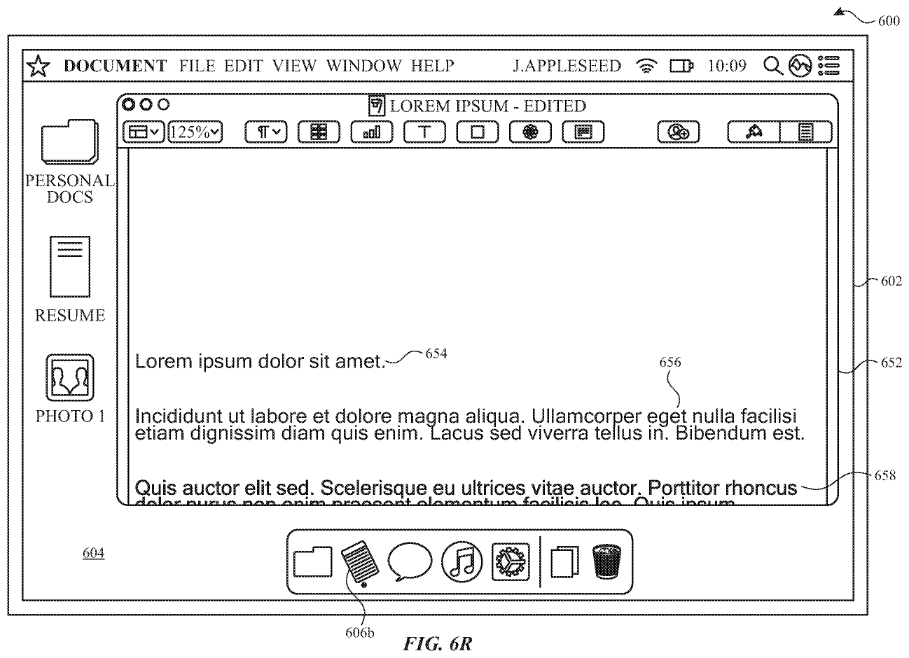

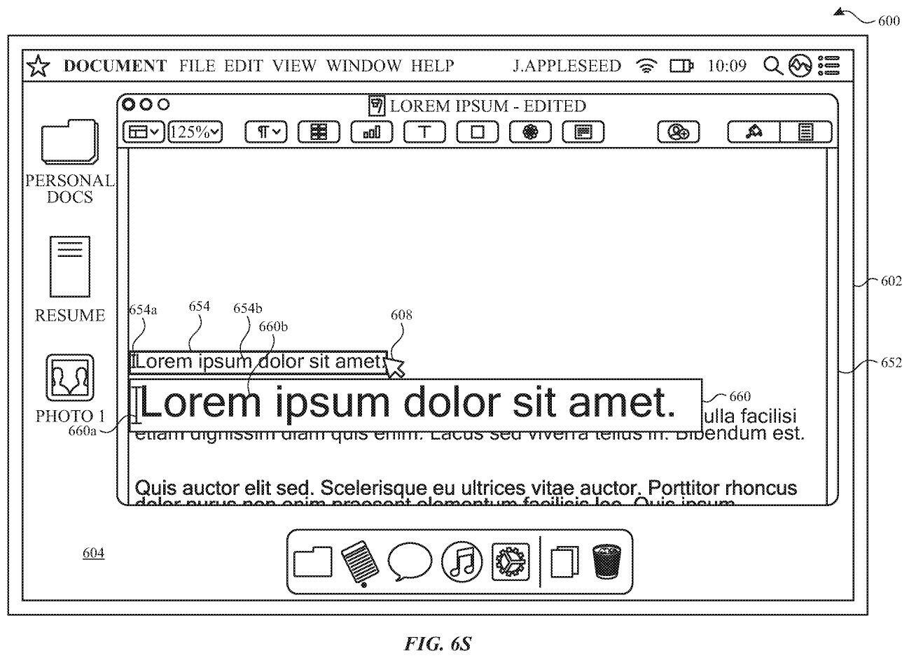

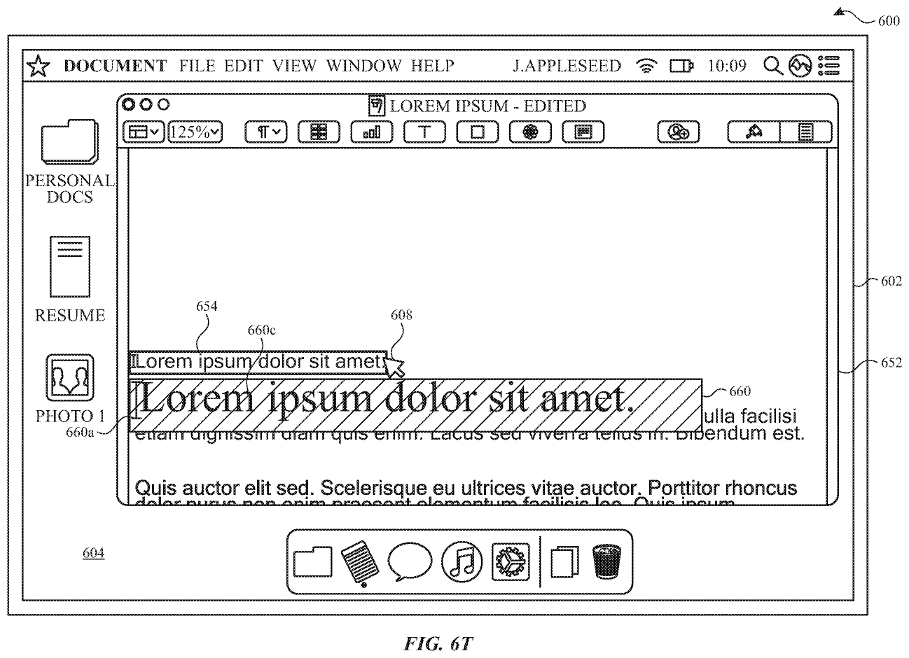

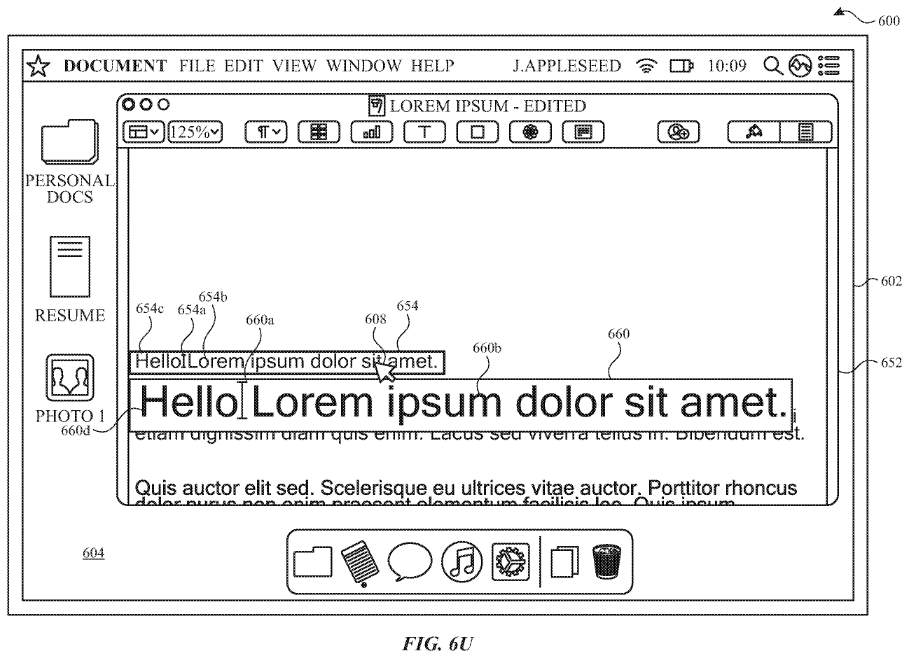

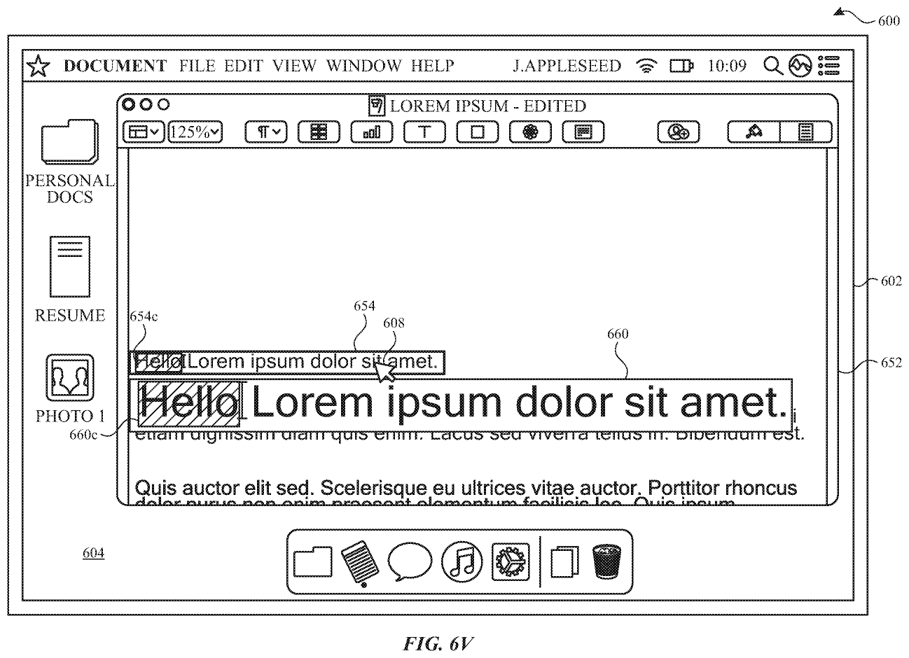

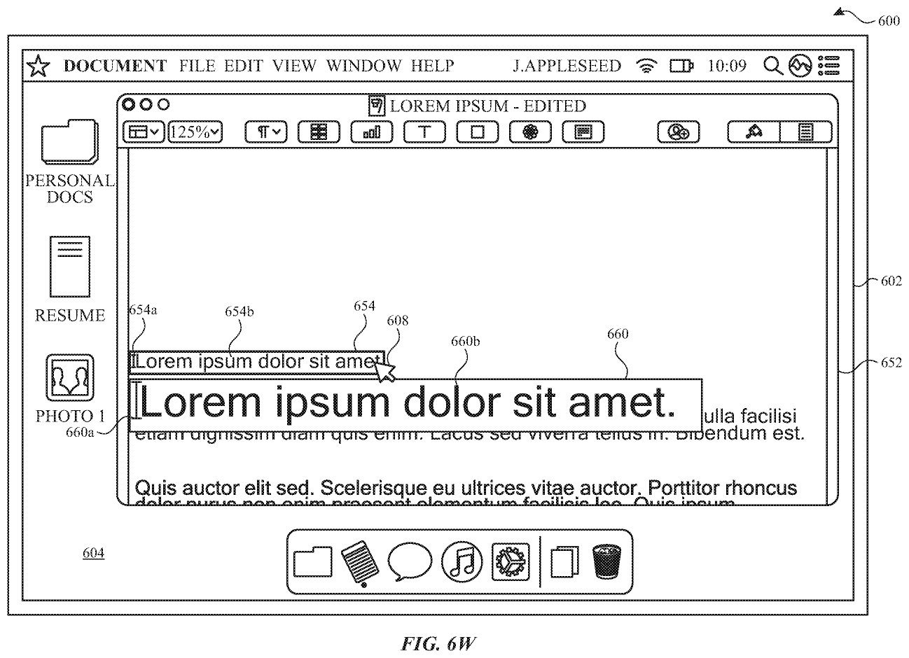

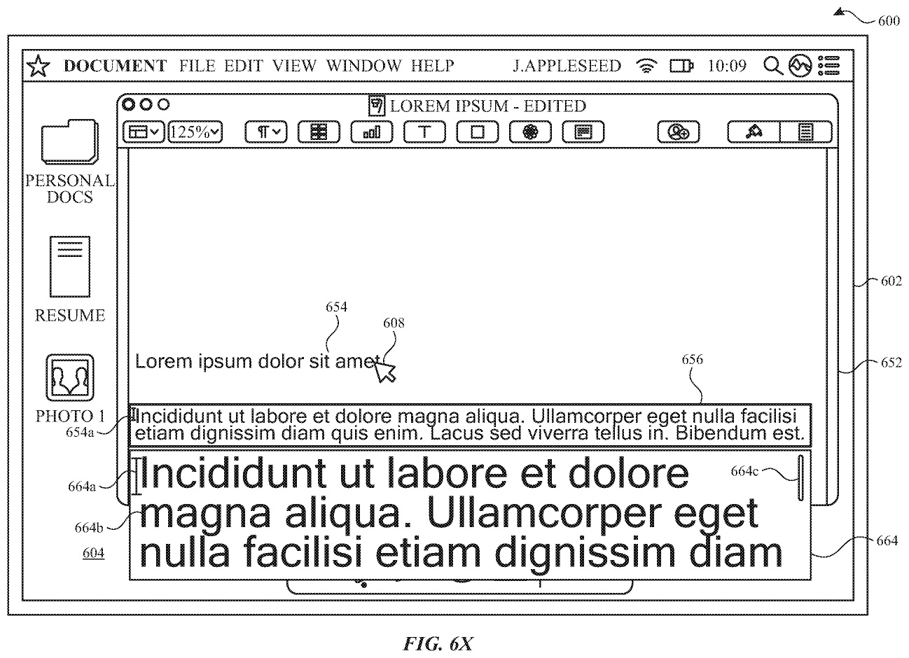

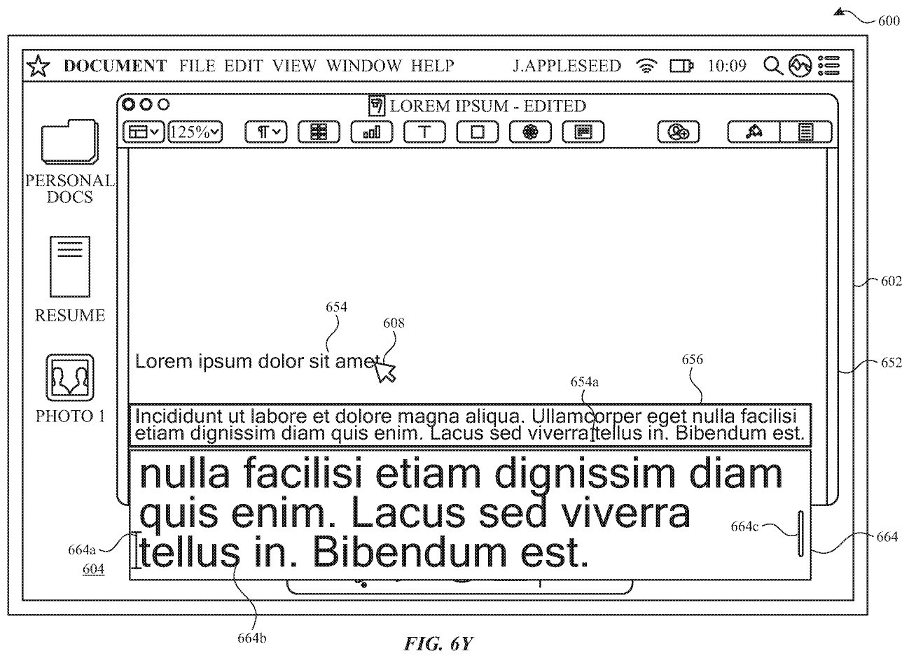

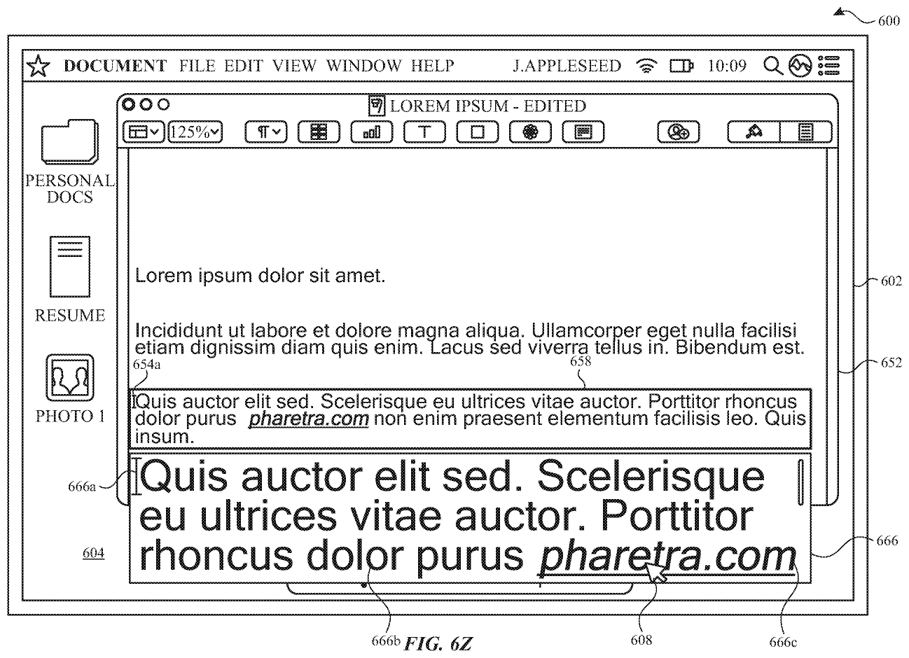

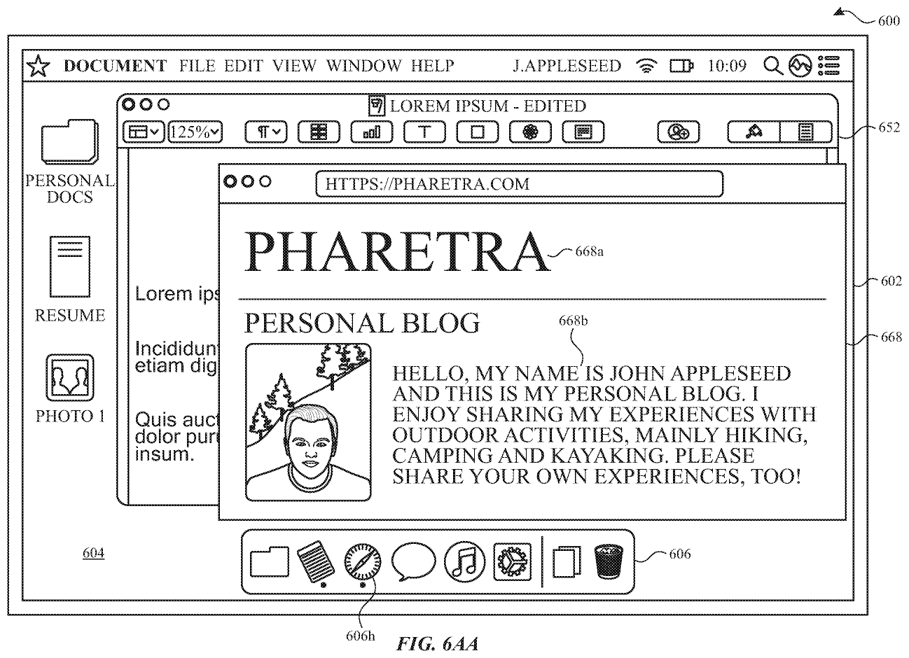

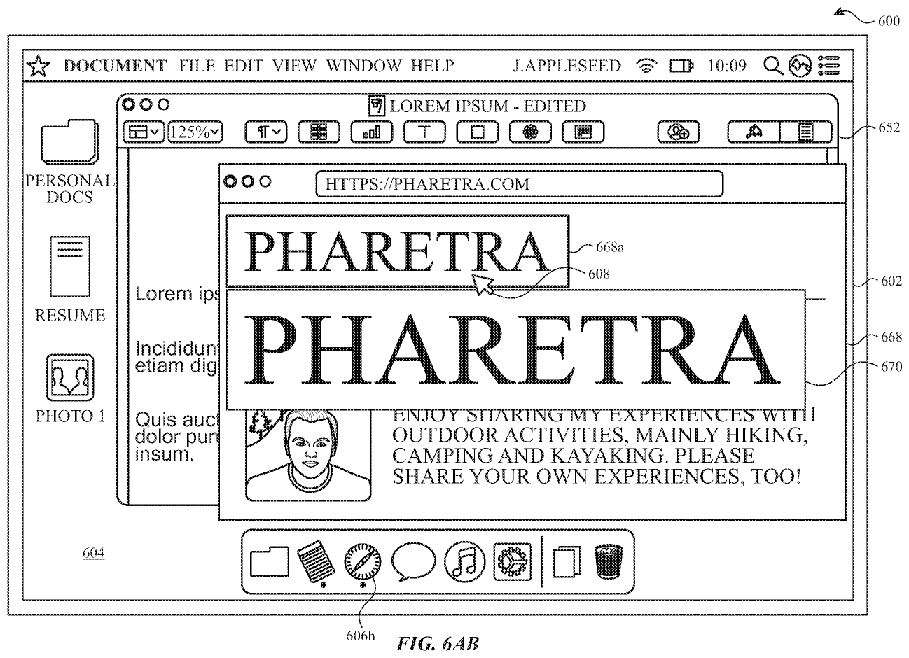

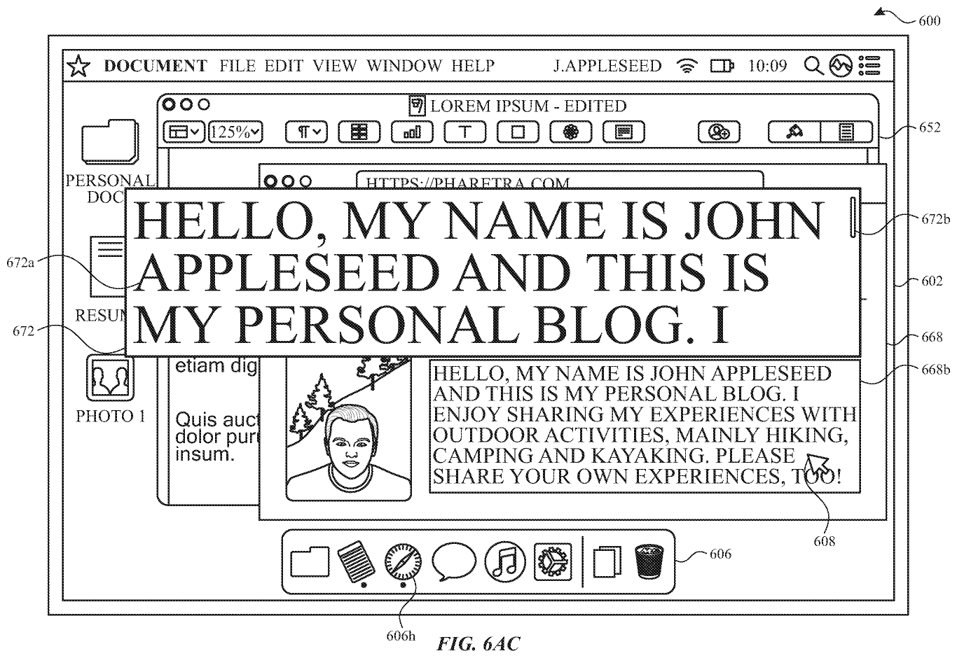

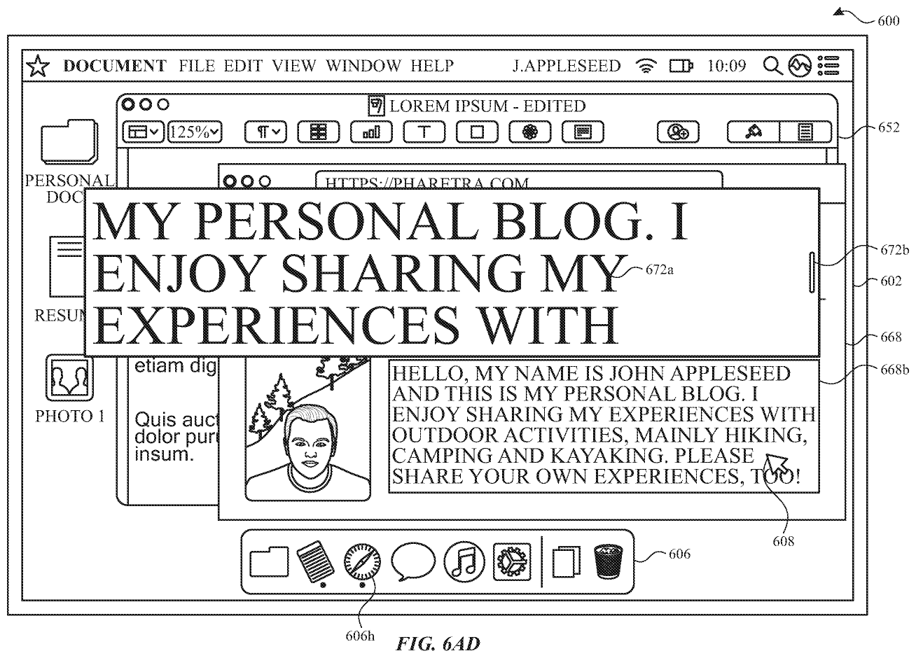

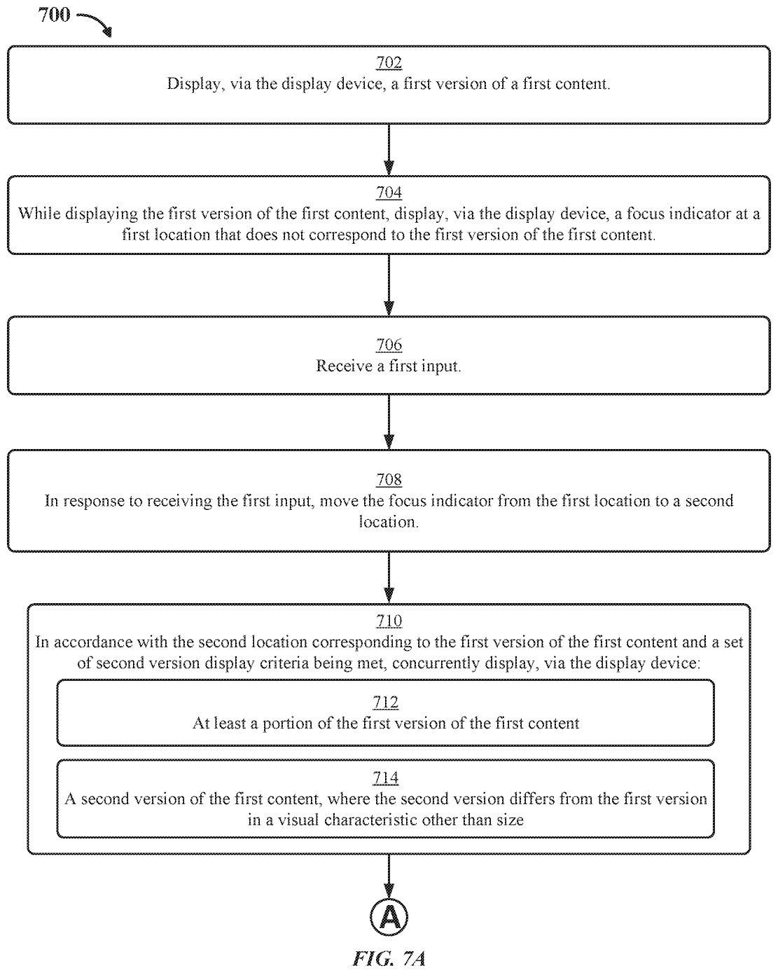

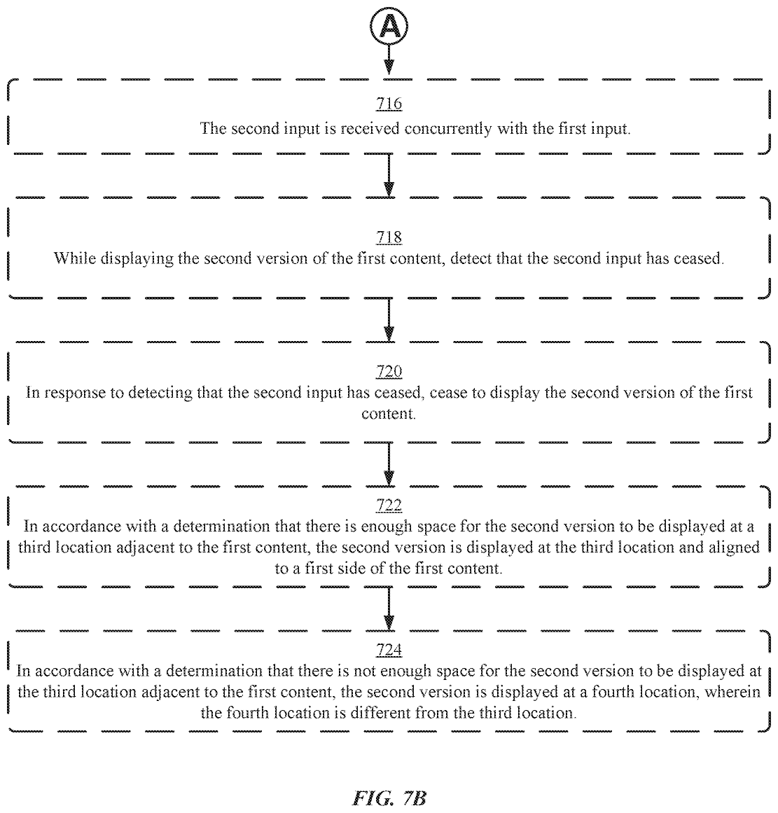

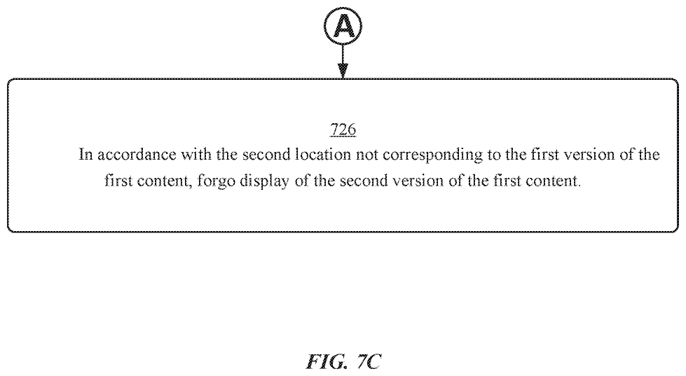

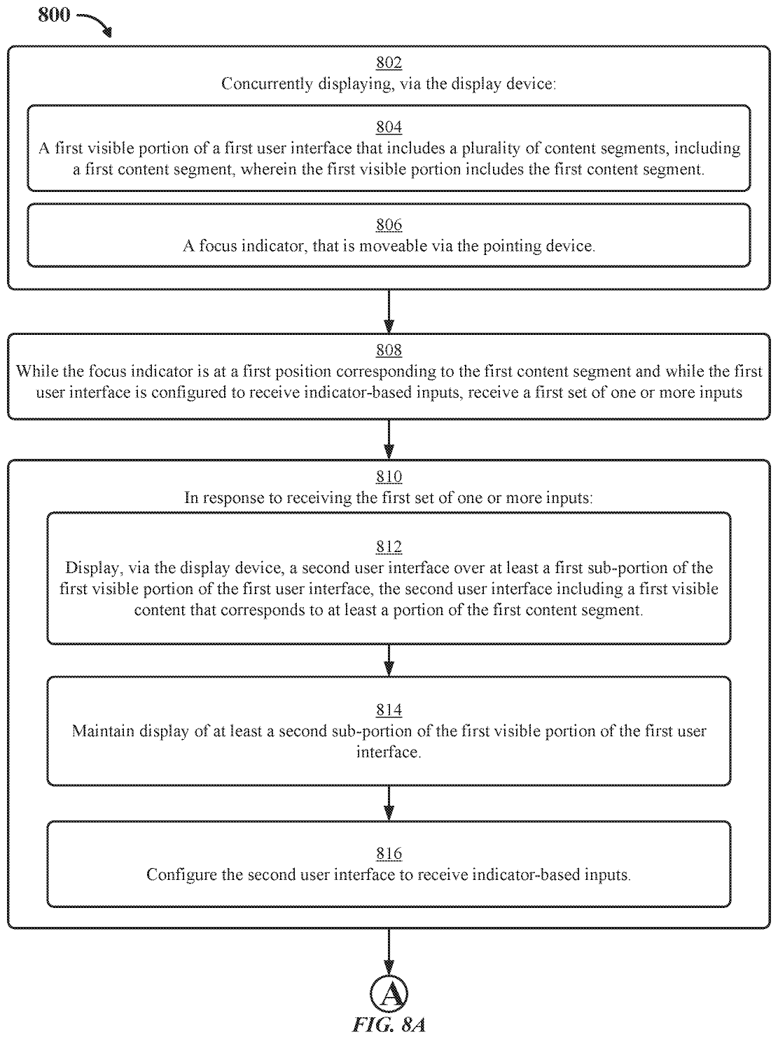

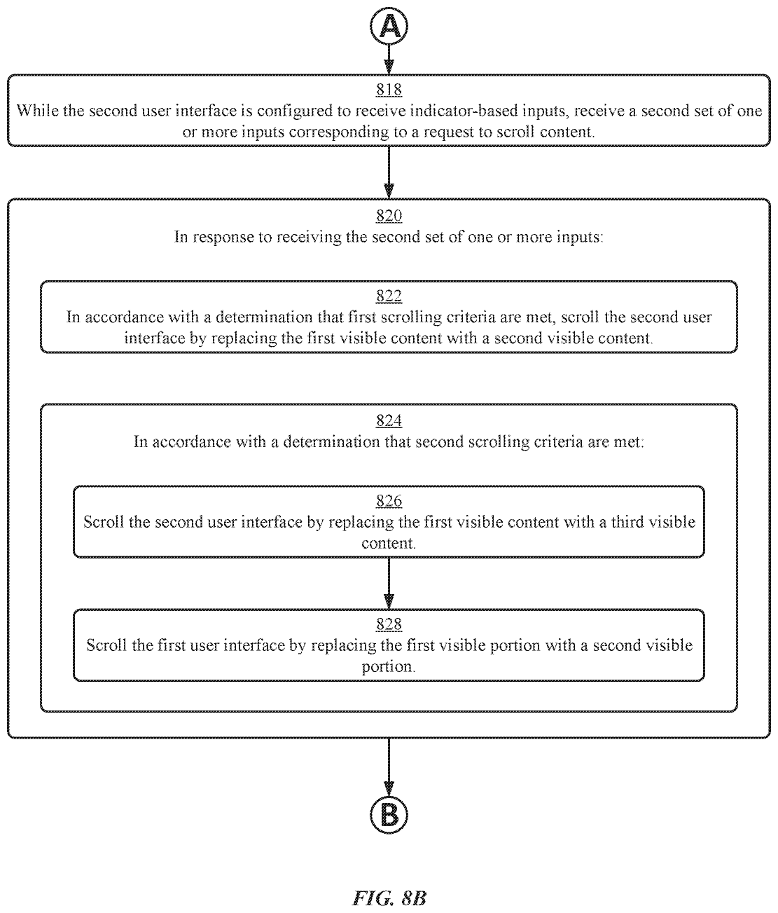

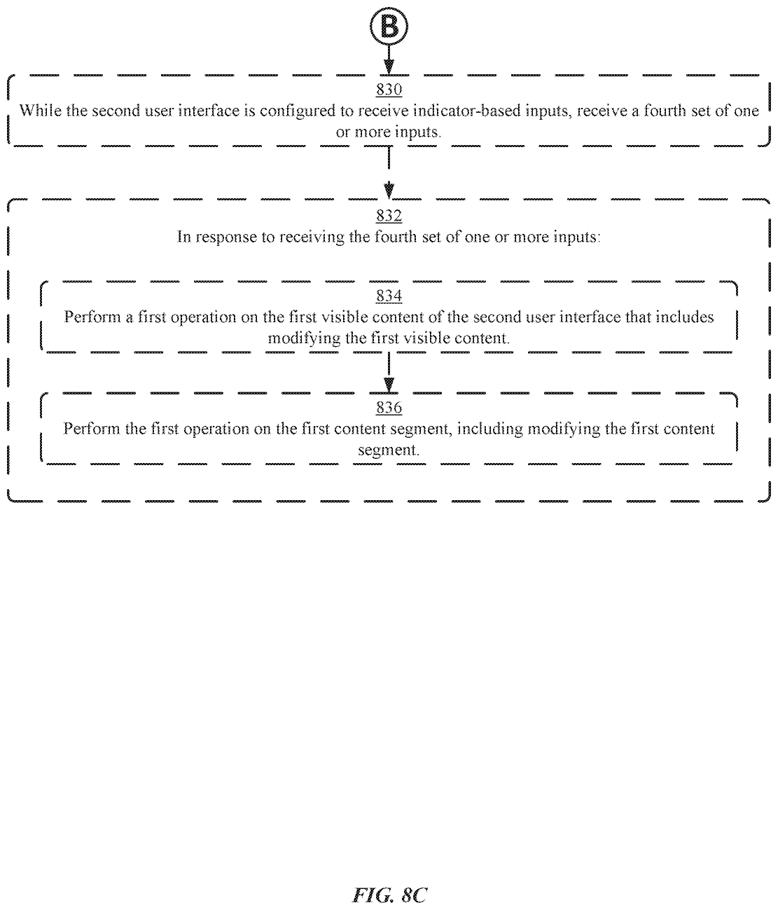

FIGS. 6A-6AD illustrate exemplary user interfaces for increasing the visibility of user interface elements, in accordance with some embodiments. FIGS. 7A-7C illustrate a flow diagram of a method for increasing the visibility of user interface elements, in accordance with some embodiments. FIGS. 8A-8C illustrate a flow diagram of a method for increasing the visibility of user interface elements, in accordance with some embodiments. The user interfaces in FIGS. 6A-6AD are used to illustrate the processes described below, including the processes in FIGS.7A-7C and 8A-8C.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

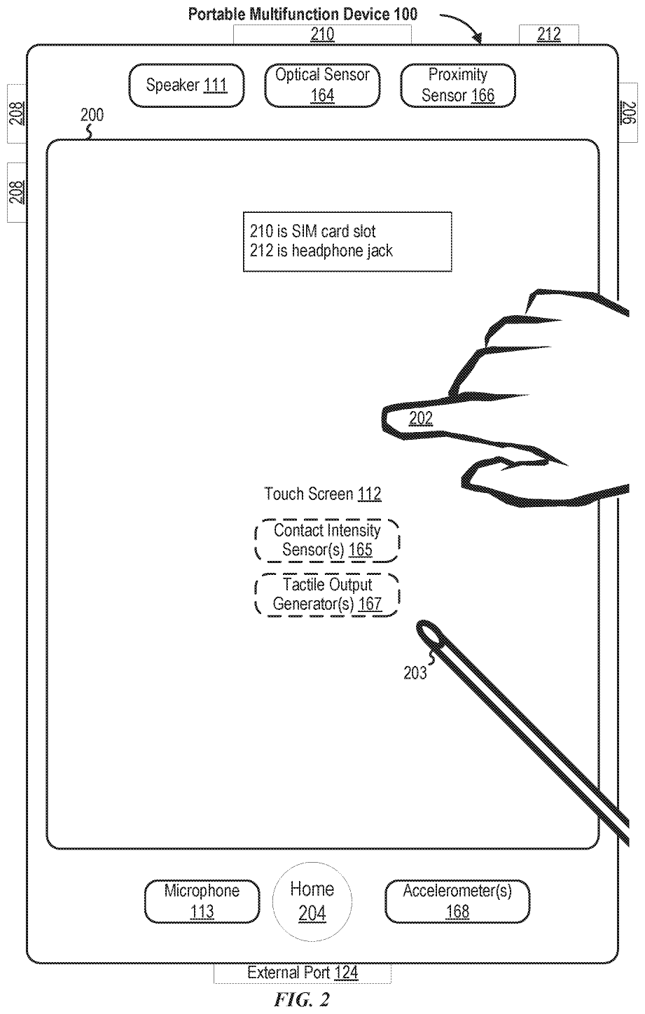

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

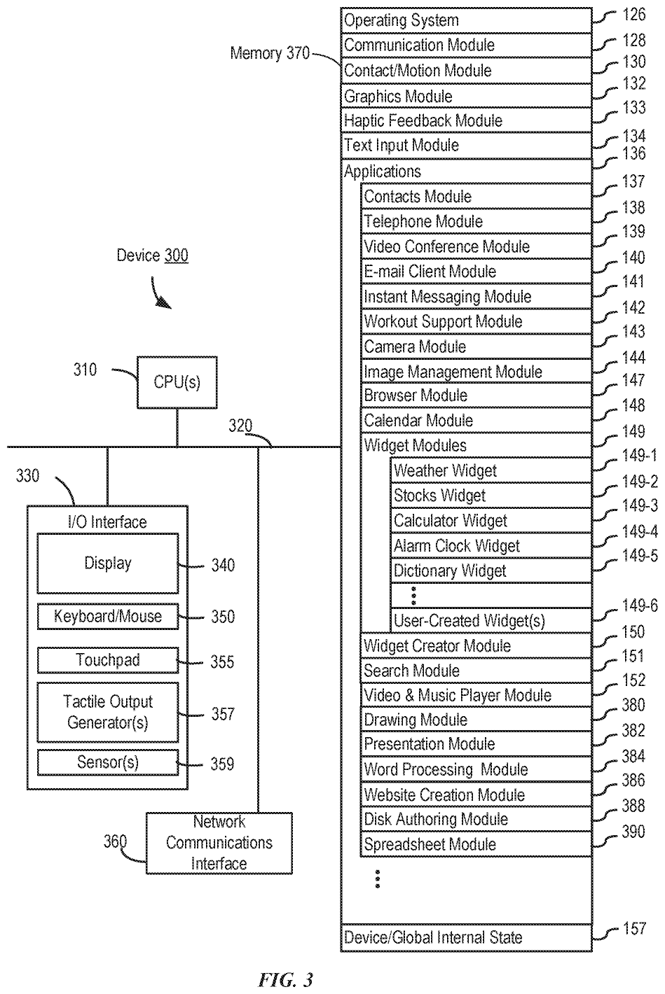

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MIMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XIVIPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

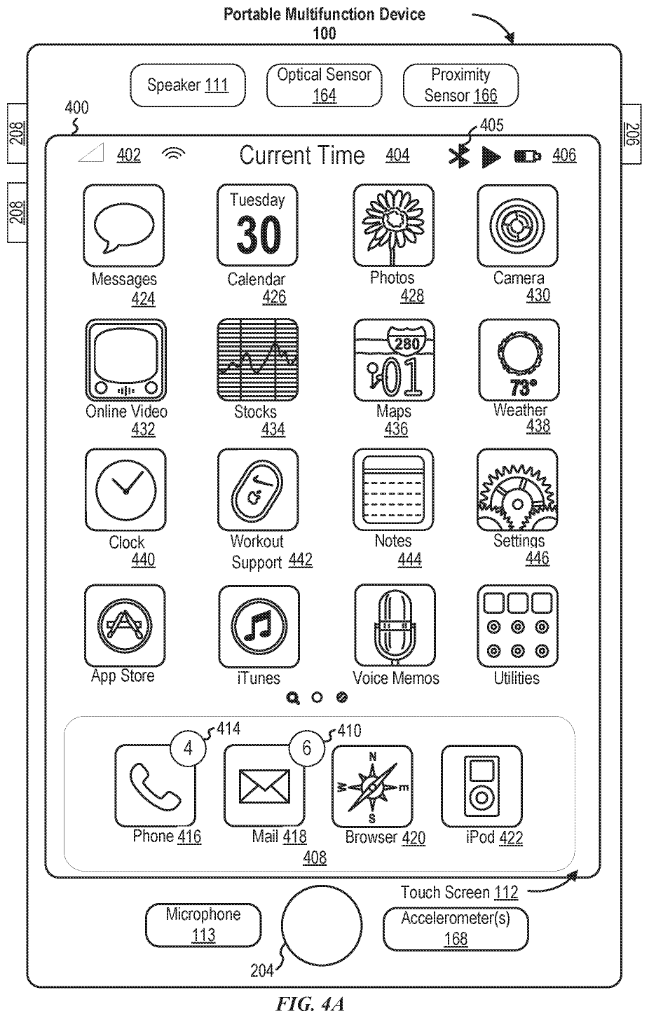

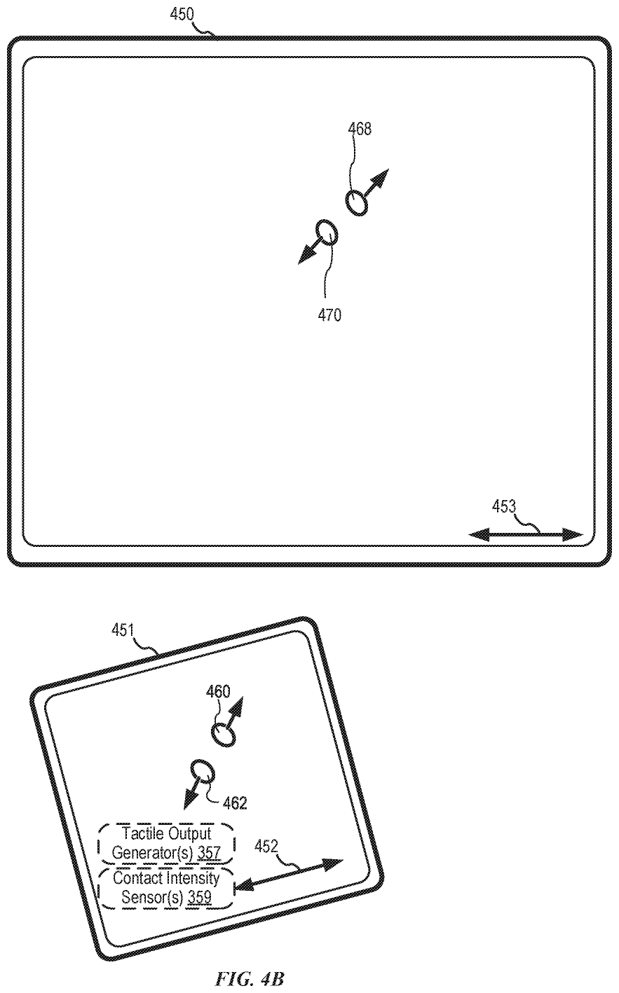

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

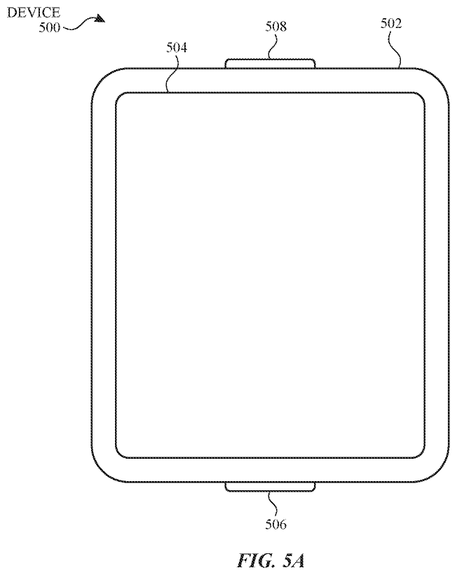

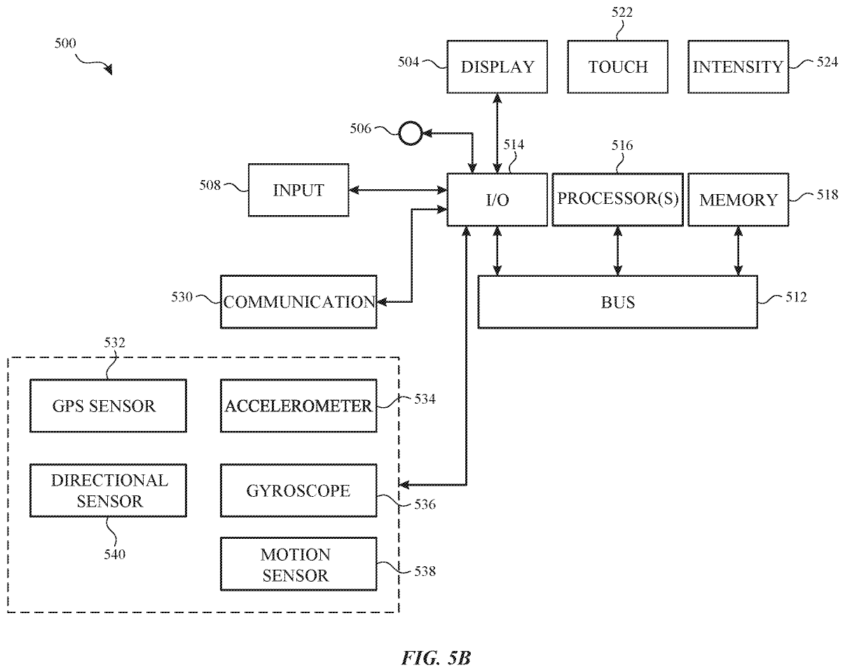

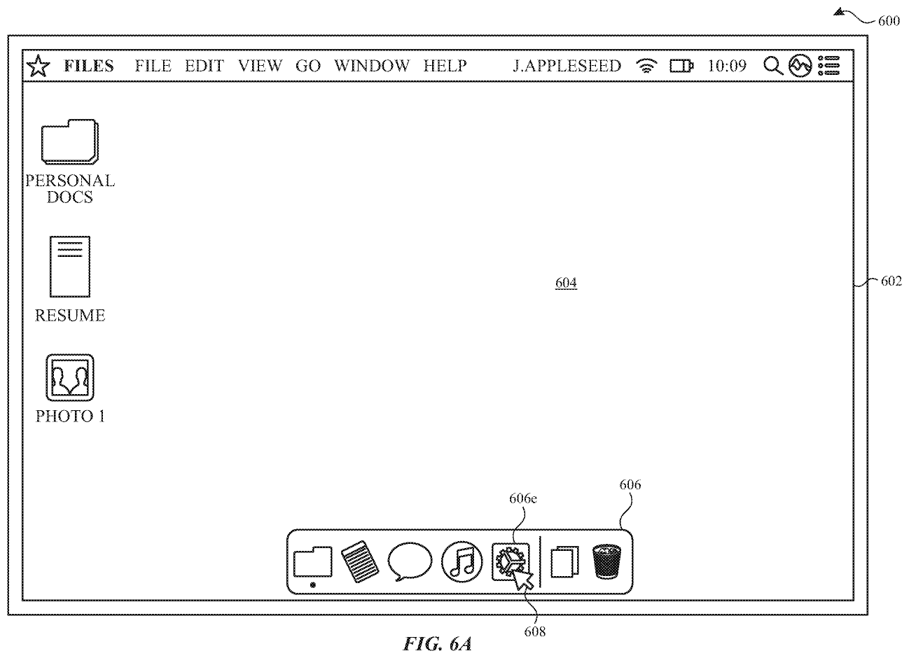

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 800 (FIGS. 7A-7C and 8A-8C). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6AD illustrate exemplary user interfaces for increasing the visibility of user interface elements, in accordance with some embodiments. The user interfaces in these figures are used to illustrate the processes described below, including the processes in FIGS. 7A-7C and 8A-8C.

FIG. 6A depicts electronic device 600 displaying desktop user interface 604 via touch-sensitive display device 602 at a first time. In some examples, electronic device 600 includes one or more features of devices 100, 300, or 500.

Desktop user interface 604 includes dock 606 with a number of icons. In some examples, each icon in dock 606 corresponds to either (1) an application, (2) a document link (e.g., a link to a file or a folder), or (3) a minimized user interface. For example, dock 606, as depicted in FIG. 6A, includes settings icon 606e corresponding to a settings application for configuring aspects of electronic device 600. Selection of settings icon 606e causes a user interface corresponding to the settings application to be displayed (e.g., on top of desktop user interface 604, as depicted in FIG. 6B).

In FIG. 6A, desktop user interface 604 further includes focus indicator 608 (e.g., a mouse cursor). As depicted in FIG. 6A, focus indicator 608 is currently at a location corresponding to settings icon 606e. While not illustrated, electronic device 600 can receive user input corresponding to selection of settings icon 606e. In one example, the user input corresponds to a left mouse click using a mouse. The left click causes an operation associated with a user interface element located where focus indicator 608 is located to execute. As depicted in FIG. 6A, the user input would cause the user interface corresponding to the settings application to be displayed.

FIG. 6B depicts electronic device 600 displaying settings user interface 610 on top of desktop user interface 604 via touch-sensitive display device 602 at a second time after the first time. In FIG. 6B, an accessibility portion of settings user interface 610 is visible. The accessibility portion allows a user to configure techniques for increasing the visibility of user interface elements, in accordance with embodiments described herein. In some examples, one or more user inputs are received to reach the accessibility portion of settings user interface 610. For example, a user input after selecting settings icon 610e may be required to navigate to the accessibility portion.

In FIG. 6B, settings user interface 610 includes (1) checkbox 610a to activate or deactivate a text-zoom operation and (2) options affordance 610b to customize how the text-zoom operation operates, as further discussed below. In some examples, the text-zoom operation causes content to be enlarged when hovering over the content while in an enlarging mode (e.g., holding a modifier key while hovering over the content or engaging the enlarging mode in response to user input), as further discussed below. In FIG. 6B, checkbox 610a is deactivated, indicating that the text-zoom operation will not execute.

FIG. 6C depicts electronic device 600 displaying settings user interface 610 on top of desktop user interface 604 via touch-sensitive display device 602 at a third time after the second time. In FIG. 6C, checkbox 610a is activated, indicating that the text-zoom operation will execute when a user provides the necessary input, as further discussed below. In some examples, checkbox 610a is activated when electronic device 600 receives user input corresponding to checkbox 610a (e.g., a selection of checkbox 610a while checkbox 610a is deactivated).

FIG. 6C also depicts focus indicator 608 at a location corresponding to options affordance 610b. In some examples, electronic device 600 receives user input corresponding to selection of options affordance 610b while focus indicator 608 is at the location. Such user input causes an options user interface to be displayed, as depicted in FIG. 6D.

FIG. 6D depicts electronic device 600 displaying options user interface 612 on top of settings user interface 610 via touch-sensitive display device 602 at a fourth time after the third time. Options user interface 612 includes multiple options for customizing the text-zoom operation described above. For example, options user interface 612 includes text size option 612a for changing a text size for the text-zoom operation (e.g., a size of text that the text-zoom operation generates when enlarging content). As depicted in FIG. 6D, the text size is currently set at 70 pt.

Options user interface 612 includes text font option 612b for customizing a text font for the text-zoom operation (e.g., a font of text that the text-zoom operation generates when enlarging content). In one example, customizing the text font for the text-zoom operation causes enlarged text to be a different font than what is being enlarged (e.g., text in an un-enlarged user interface is Times New Roman while text in an enlarged user interface corresponding to the text in the un-enlarged user interface is Arial). By customizing the text font, a user can cause the enlarged text to always be the same font, a font that the user can easily read. As depicted in FIG. 6D, text font option 612b is set as “Default.” In some examples, default means that the text-zoom operation will use a predefined font when enlarging text (e.g., a system font). In other examples, default means that the text-zoom operation will use whatever font is used in the underlying content (e.g., if text in an un-enlarged user interface is Times New Roman, text in an enlarged user interface corresponding to the text in the un-enlarged user interface would also be Times New Roman).

Options user interface 612 includes activation modifier option 612c for customizing the key that that the user must press to execute the text-zoom operation. In some examples, the text-zoom operation is executed when electronic device 600 receives user input indicating to perform the text-zoom operation. Such user input, in some examples, corresponds to a key that a user must press to execute the text-zoom operation. As depicted in FIG. 6D, the key used for the text-zoom operation is the option key. In other examples, the key is another key, such as the control key, the command key, or a combination of keys.

Options user interface 612 includes text-entry location option 612d for customizing a location where the text-zoom operation outputs its enlarged text if able (e.g., the location is a preferred location when there is enough room in the location for the enlarged text to be displayed). As depicted in FIG. 6D, the location is near a current line where the text that is being enlarged is located. In some examples, when outputting near the current line, the text-zoom operations outputs enlarged text so as to be left justified and below the text that is being enlarged. Other examples of locations for where the text-zoom operation outputs its enlarged text include top left, top right, bottom left, bottom right, or custom (such that a user can specify where the enlarged text should be located).

Options user interface 612 includes a number of different options to customize colors associated with the text-zoom operation. For example, options user interface 612 includes text color option 612e for customizing a text color for the text-zoom operation (e.g., a color of text that the text-zoom operation generates when enlarging content). While a user can pick any color for text, FIG. 6D depicts text color option 612e is set as default. Default means that the text-zoom operation will generate text in a color predefined by a system (e.g., an operating system of electronic device 600 or a system corresponding to text-zoom operation) or an application including content that is being enlarged. For example, default text color can cause text that already has a color in an application to be reflected in text generated by the text-zoom operation (e.g., the generated text would be the same color as the text in the application). In some examples, if a user specifies a text color, the text-zoom operation would ignore the default color and generate text in the color specified by the user.

Options user interface 612 includes insertion-point color option 612f for customizing a color of an insertion point generated by the text-zoom operation. While a user can pick any color for the insertion point (sometimes referred to as an insertion marker herein), FIG. 6D depicts insertion-point color option 612f is set as default. Default means that the text-zoom operation will generate an insertion point in a color predefined by a system (e.g., an operating system of electronic device 600 or a system corresponding to text-zoom operation) or an application including content that is being enlarged. For example, default insertion-point color would mean that an insertion marker that already has a color in an application would be reflected in content generated by the text-zoom operation (e.g., the generated insertion marker would be the same color as the insertion marker in the application). If a user specifies a color, the text-zoom operation would ignore the default color and generate the insertion marker in the color specified by the user.

Options user interface 612 includes background color option 612g for customizing a background color for the text-zoom operation (e.g., a color of the background of the user interface that the text-zoom operation generates to include enlarged content). While a user can pick any color for the background, FIG. 6D depicts background color option 612g is set as default. Default means that the text-zoom operation will generate text in a color predefined by a system (e.g., an operating system of electronic device 600 or a system corresponding to text-zoom operation) or an application including content that is being enlarged. In some examples, default background color would mean that the background would be whatever color is predefined by the text-zoom operation (e.g., always white or always black). In other examples, default background color would mean that the background would be whatever color the background of the content that being enlarged is. If a user specifies a background color, the text-zoom operation would ignore the default color and generate the background in the color specified by the user.

Options user interface 612 includes border color option 612h for customizing a border color for the text-zoom operation (e.g., a border of the user interface generated by the text-zoom operation to include content being enlarged by the text-zoom operation). While a user can pick any color for the border color, FIG. 6D depicts border color option 612h is set as default. Default means that the text-zoom operation will generate the border in a color predefined by a system (e.g., an operating system of electronic device 600 or a system corresponding to text-zoom operation) or an application including content that is being enlarged. In some examples, default text color would mean that text that the border would be whatever color is predefined by the text-zoom operation (e.g., black). If a user specifies a border color, the text-zoom operation would ignore the default color and generate the border in the color specified by the user.

Options user interface 612 includes element-highlight color option 612e for customizing an element-highlight color for the text-zoom operation (e.g., a color of a graphic (such as an outline) surrounding content that is being enlarged by the text-zoom operation). While a user can pick any color for the element highlight, FIG. 6D depicts element-highlight color option 612e is set as default. Default means that the text-zoom operation will generate a graphic surrounding content being enlarged in a color predefined by a system (e.g., an operating system of electronic device 600 or a system corresponding to text-zoom operation) or an application including content that is being enlarged. For example, default text color would mean that the element highlight would be whatever color is predefined by the text-zoom operation (e.g., yellow). If a user specifies a color, the text-zoom operation would ignore the default color and generate the element highlight in the color specified by the user.

In some examples, options user interface 612 includes a foreground option (not illustrated) for modifying foreground color for the text-zoom operation (e.g., a color of any content generated by the text-zoom operation based on non-enlarged content (e.g., text or graphic (such as an icon or a checkbox) not including background). In such examples, color of icons, text, and graphics can be modified to be in accordance with the configured foreground color.

Options user interface 612 includes ok affordance 612j for closing options user interface 612.

FIG. 6E depicts electronic device 600 displaying options user interface 612 on top of settings user interface 610 via touch-sensitive display device 602 at a fifth time after the fourth time. In FIG. 6E, electronic device 600 has received user input corresponding to selection of an affordance corresponding to text color option 612a for displaying a dropdown menu, causing dropdown menu 614 to be displayed via touch-sensitive display device 602. Dropdown menu 614 includes a representation for default (which is currently selected, shown by check mark next to the text “default”) and a number of particular colors for which a user may choose from.

FIG. 6E depicts use of the text-zoom operation on a visual representation of a color in dropdown menu 614. In particular, FIG. 6E depicts electronic device 600 displaying overlay 616. In some examples, overlay 616 is displayed in response to a determination that electronic device 600 is in an enlarging mode (e.g., holding a modifier key or locking into the enlarging mode using a locking user action, such as a key to transition into the enlarging mode until the key is activated again) while focus indicator 608 is corresponding to a location of the visual representation. In some examples, when electronic device 600 transitions from the enlarging mode to a regular mode, overlay 616 ceases to be displayed. In some examples, electronic device 600 transitions from the enlarging mode to the regular mode when the modifier key is released. In some examples, overlay 616 also ceases to be displayed when focus indicator 608 is moved to a location that no longer corresponds to the location of the visual representation.

Overlay 616 includes a representation of the color corresponding to the visual representation in a size larger than that depicted in dropdown menu 614. In some examples, the representation is generated by an asset corresponding to the visual representation. For example, the text-zoom operation can identify the color corresponding to the visual representation and then generate an enlarged area of the color, instead of scaling the visual representation. Such a process can allow the visual representation to be displayed in a larger size without losing resolution. Thus, while terms such as enlarging may be used to describe the processes described herein, enlarging does not necessarily refer to merely scaling a representation or object.

In some examples, in addition to causing overlay 616 to be displayed, the text-zoom operation also causes an element highlight to be displayed around item 614e (which includes the visual representation) to indicate to a user that a portion of item 614e is being enlarged, similar to as discussed above. In other examples, the text-zoom operation causes an element highlight to be displayed around only the visual representation (instead of all of item 614e) to indicate to a user that the visual representation is being enlarged and not the rest of item 614e. In such examples, the text-zoom operation can enlarge all of item 614e when focus indicator 608 is located at a location corresponding to item 614e but not corresponding to the visual representation.

FIG. 6F depicts electronic device 600 displaying overlay 622 via touch-sensitive display device 602 at a sixth time after the fifth time. In FIG. 6F, electronic device 600 has received user input corresponding to movement of focus indicator 608 to icon 618. The movement causes focus indicator 608 to be at a location corresponding to icon 618. When focus indicator 608 is at the location and electronic device 600 is in an enlarging mode (e.g., holding a modifier key or locking into the enlarging mode using a locking user action, such as a key to transition into the enlarging mode until the key is activated again), the text-zoom operation causes electronic device 600 to display overlay 622 with a representation of icon 618 at a location below and left justified to icon 618. The representation is a textual description of icon 618 at a font size defined in options discussed above. This is an example of an icon that is enlarged as text without a graphical representation of icon 618.

In some examples, in addition to causing overlay 622 to be displayed, the text-zoom operation also causes element highlight 620 to be displayed around icon 618 to indicate to a user that icon 618 is being enlarged, similar to as discussed above.

FIG. 6G depicts electronic device 600 displaying overlay 628 via touch-sensitive display device 602 at a seventh time after the sixth time. In FIG. 6G, electronic device 600 has received user input corresponding to movement of focus indicator 608 to icon 606c. The movement causes focus indicator 608 to be at a location corresponding to icon 606c. When focus indicator 608 is at the location and electronic device 600 is in an enlarging mode (e.g., holding a modifier key or locking into the enlarging mode using a locking user action, such as a key to transition into the enlarging mode until the key is activated again), the text-zoom operation causes electronic device 600 to display overlay 628 with a representation of icon 606c at a location above and left justified to icon 606c (in some examples, overlay 628 is displayed above icon 606c because there is not enough room for overlay 628 to be displayed below icon 606c).

The representation includes a textual description of icon 606c (e.g., 628b, “MESSAGES”) at a font size defined in options discussed above and a graphical representation of icon 606c at a size larger than icon 606c. This is an example of an icon that is enlarged as text and a graphical representation of icon 606c. In some examples, the graphical representation of icon 606c is a different asset from icon 606c so that graphical representation of icon 606c is not merely a scaled version of icon 606c but its own asset that is generated at the size displayed. In other examples, the asset used to display icon 606c is a vector graphic such that the vector graphic can be used to create the graphical representation of icon 606c without sacrificing resolution. Such techniques allow the graphical representation of icon 606c to have a sharper appearance because it is not just scaling icon 606c.

In some examples, in addition to causing overlay 628 to be displayed, the text-zoom operation also causes element highlight 626 to be displayed around icon 606c to indicate to a user that icon 606c is being enlarged, similar to as discussed above.

In some examples, electronic device further displays description 624a to provide a description of icon 606c. In some examples, description 624a is displayed be a process separate from the text-zoom operation and is displayed under overlay 628. In other examples, description 624a is suppressed (e.g., not displayed) while overlay 628 is displayed (not illustrated in FIG. 6G).

FIG. 6H depicts electronic device 600 displaying overlay 628 via touch-sensitive display device 602 at an eighth time after the seventh time. Between the seventh time and the eighth time, electronic device 600 receives two messages corresponding to icon 606c and displays indicator 624b to represent that these two messages have been received. When indicator 624b is displayed, overlay 628, in some examples, is updated to reflect indicator 624b. In FIG. 6H, overlay 628 has been updated to remove the graphical representation of icon 606c and add representation 628c (e.g., “2”) of indicator 624b. In some examples, overlay 628 maintains the graphical representation of icon 606c and adds representation 628c (not illustrated).

FIG. 61 depicts electronic device 600 displaying overlay 632 via touch-sensitive display device 602 at a ninth time after the eighth time. In FIG. 61, electronic device 600 has received user input including input corresponding to movement of focus indicator 608 to dropdown menu 630. In some examples, the user input includes selection of files affordance 630a, which caused display of dropdown menu 630 and then movement to item 630b in dropdown menu 630. When focus indicator 608 is at a location corresponding to item 630b and electronic device 600 is in an enlarging mode (e.g., holding a modifier key or locking into the enlarging mode using a locking user action, such as a key to transition into the enlarging mode until the key is activated again), the text-zoom operation causes electronic device 600 to display overlay 632 with a representation of item 630b at a location below and left justified to item 630b. The representation is a textual description of item 630b (e.g., “MAXIMIZE WINDOW”) at a font size defined in options discussed above. This is an example of an item that is enlarged as text without a graphical representation of the item. In some examples, the representation is generated by identifying the text in item 630b and then generating the text at a size needed for overlay 632, instead of just scaling item 630b.

In some examples, in addition to causing overlay 632 to be displayed, the text-zoom operation also causes an element highlight to be displayed around item 630b to indicate to a user that item 630b is being enlarged, similar to as discussed above.

FIG. 6J depicts electronic device 600 displaying overlay 634 via touch-sensitive display device 602 at a tenth time after the ninth time. In FIG. 6J, electronic device 600 has received user input corresponding to movement of focus indicator 608 to item 630c. When focus indicator 608 is at a location corresponding to item 630c and electronic device 600 is in an enlarging mode (e.g., holding a modifier key or locking into the enlarging mode using a locking user action, such as a key to transition into the enlarging mode until the key is activated again), the text-zoom operation causes electronic device 600 to display overlay 634 with a representation of item 630c at a location below and left justified to item 630c. The representation is a textual description of item 630c (e.g., “TURN OFF MAGNIFICATION”) at a font size defined in options discussed above. This is another example of an item that is enlarged as text without a graphical representation of the item.

In some examples, in addition to causing overlay 634 to be displayed, the text-zoom operation also causes an element highlight to be displayed around item 630c to indicate to a user that item 630c is being enlarged, similar to as discussed above.

FIG. 6K depicts electronic device 600 displaying search area 636 via touch-sensitive display device 602 at an eleventh time after the tenth time. In FIG. 6K, electronic device 600 has received user input corresponding to entering a character “S” into search area 636. For example, in one example, a user enters the character “S” using a keyboard (e.g., physical or virtual keyboard) associated with electronic device 600 while search area 636 is being focused on (e.g., an insertion marker has been inserted in search area 636 due to a user clicking within search area 636).

In FIG. 6K, electronic device 600 has also received user input corresponding to movement of focus indicator 608 to search area 636. When focus indicator 608 is at a location corresponding to search area 636 and electronic device 600 is in an enlarging mode (e.g., holding a modifier key or locking into the enlarging mode using a locking user action, such as a key to transition into the enlarging mode until the key is activated again), the text-zoom operation causes electronic device 600 to display overlay 638 with a representation of search area 636 at a location below and left justified to search area 636. The representation is a textual description of item 630b (e.g., “S”) at a font size defined in options discussed above. The representation also includes an insertion marker in a location corresponding to a second insertion marker located in search area 636. This is an example of an area that is enlarged as text without a graphical representation of a portion of the item (e.g., the magnifying glass is not included in the representation). In some examples, the representation is displayed before receiving user input corresponding to the character “S” such that the representation is updated in response to receiving the user input corresponding to the character “S.” In other words, the representation and search area 636 are updated to include the character “S” approximately simultaneously.

In some examples, in addition to causing overlay 638 to be displayed, the text-zoom operation also causes an element highlight to be displayed around search area 636to indicate to a user that search area 636 is being enlarged, similar to as discussed above.

FIG. 6L depicts electronic device 600 displaying search area 636 via touch-sensitive display device 602 at a twelfth time after the eleventh time. In FIG. 6L, electronic device 600 is displaying results of a search performed using search area 636. For example, as indicated above for FIG. 6K, a user has entered the character “S.” FIG. 6L depicts a search results for the character “S.” The search results include multiple representations of the search results in a list form, the multiple representations including first search result 636a.

In some examples, overlay 640 is displayed in response to user input indicating to move from search area 636 to the search results. For example, the user input can correspond to a press of a down button when an insertion marker is in search area 636. The user input indicates that a user wishes to view a first search result (e.g., first search result 636a). In other examples, overlay 640 is displayed in response to first search result 636a being displayed. In some examples, search area 636 is enlarged via an overlay (e.g., overlay 638) until search results are displayed, and then, after a threshold amount of time has passed, overlay 640 is displayed.

In some examples, overlay 640 includes a representation of first search result 636a at a location below and left justified to first search result 636a. The representation is a textual description of first search result 636a (e.g., “SCREEN SHOT”) at a font size defined in options discussed above. This is another example of an item that is enlarged as text without a graphical representation of the item. In some examples, overlay 640 is displayed while focus indicator 608 is still at a location corresponding to search area 636.

In some examples, in addition to causing overlay 640 to be displayed, the text-zoom operation also causes an element highlight to be displayed around first search result 636a to indicate to a user that first search result 636a is being enlarged, similar to as discussed above. In such examples, the element highlight around search area 636 and overlay 638 are no longer displayed.

FIG. 6M depicts electronic device 600 displaying overlay 642 via touch-sensitive display device 602 at a thirteenth time after the twelfth time. In some examples, overlay 642 is displayed in response to user input indicating to move from first search result 636a to fifth search result 636e. For example, the user input can correspond to four presses of a down button when first search result 636a is currently highlighted. The user input indicates that a user wishes to view fifth search result 636e.

In some examples, overlay 642 includes a representation of fifth search result 636e at a location below and left justified to fifth search result 636e. The representation is a textual description of fifth search result 636e (e.g., “SYSTEM PREFERENCES”) at a font size defined in options discussed above. This is example of an item that is enlarged as text without abbreviations when the un-enlarged item includes an abbreviation. Another example of such a feature is with a meeting representation for a calendar. In such an example, the meeting representation might only include some information due to space constraints. An enlarged version of the meeting representation, according to techniques described herein, can include additional information not visually included in the meeting representation (e.g., full name associated with the meeting representation, participants corresponding to the meeting representation, a location associated with the meeting representation, etc.).

In some examples, in addition to causing overlay 642 to be displayed, the text-zoom operation also causes an element highlight to be displayed around fifth search result 636e to indicate to a user that fifth search result 636e is being enlarged, similar to as discussed above. In such examples, the element highlight around first search result 636a and overlay 640 are no longer displayed. In some examples, movement of focus indicator 608 to a location not corresponding to search area 636 would cause would cause any overlay being displayed for search results to cease to be displayed (e.g., if focus indicator 608 is moved away from search area 636 in FIG. 6L, overlay 640 would cease to be displayed; and if focus indicator 608 is moved away from search area 636 in FIG. 6M, overlay 642 would cease to be displayed).

FIG. 6N depicts electronic device 600 displaying overlay 646 via touch-sensitive display device 602 at a fourteenth time after the thirteenth time. In some examples, overlay 646 is displayed in response to focus indicator 608 being located at a location corresponding to radio button 644b in user interface 644 and electronic device 600 being in an enlarging mode (e.g., holding a modifier key or locking into the enlarging mode using a locking user action, such as a key to transition into the enlarging mode until the key is activated again).

Overlay 646 is displayed at a location below and left justified to radio button 644b with a representation of radio button 644b. The representation includes a textual description of item 630b (e.g., “SCALED”) at a font size defined in options discussed above. The representation further includes a graphical representation of a radio button included with radio button 644b. The graphical representation of the radio button is larger than and depicted as being active to match the radio button included with radio button 644b. This is an example of an item that is enlarged as text with a graphical representation of a manipulate-able object (e.g., a radio button). Similar graphical representations can be used for other manipulate-able objects, such as a checkbox. In some examples, instead of including the graphical representation, the representation can include textual information indicating status of the radio button, such as “SCALED (SELECTED).”

In some examples, in addition to causing overlay 646 to be displayed, the text-zoom operation also causes an element highlight to be displayed around radio button 644b to indicate to a user that radio button 644b is being enlarged, similar to as discussed above.

FIG. 60 depicts electronic device 600 displaying overlay 648 via touch-sensitive display device 602 at a fifteenth time after the fourteenth time. In FIG. 60, electronic device 600 has received user input corresponding to movement of focus indicator 608 to radio button 644a. When focus indicator 608 is at a location corresponding to radio button 644a and electronic device 600 is in an enlarging mode (e.g., holding a modifier key or locking into the enlarging mode using a locking user action, such as a key to transition into the enlarging mode until the key is activated again), the text-zoom operation causes electronic device 600 to display overlay 648 with a representation of radio button 644a at a location below and left justified to radio button 644a. The representation includes a textual description of radio button 644a (e.g., “DEFAULT FOR DISPLAY”) at a font size defined in options discussed above. The representation further includes a graphical representation of a radio button included with radio button 644a. The graphical representation of the radio button is larger than and depicted as being inactive to match the radio button included with radio button 644a. This is another example of an item that is enlarged as text with a graphical representation of a manipulate-able object (e.g., a radio button). In some examples, instead of including the graphical representation, the representation can include textual information indicating status of radio button, such as “DEFAULT FOR DISPLAY (NOT SELECTED).”

In some examples, in addition to causing overlay 648 to be displayed, the text-zoom operation also causes an element highlight to be displayed around radio button 644a to indicate to a user that radio button 644a is being enlarged, similar to as discussed above.

FIG. 6P depicts user input affecting overlay 648 at a sixteenth time after the fifteenth time. In FIG. 6P, electronic device 600 has received first user input corresponding to a transition to a locked mode (sometimes referred to as a detached mode) so that focus indicator 608 can be moved without forgoing display of overlay 648. In some examples, the first user input corresponds to activation of a key of a keyboard (either virtual or physical), such as a control key. In some examples, the first user input must be received concurrently with the modifier key to allow focus indicator 608 to be moved without forgoing display of overlay 648 (e.g., as soon as either the first user input or the modifier key is released, display of overlay 648 is ceased). In some examples, the first user input must be received after a locking user action (such as a key to transition into the enlarging mode until the key is activated again) to allow focus indicator 608 to be moved without forgoing display of overlay 648 (e.g., as soon as either the first user input is released or the key to transition into the enlarging mode is activated again, display of overlay 648 is ceased). In some examples, the first user input must be before displaying overlay 648 to allow focus indicator 608 to be moved without forgoing display of overlay 648 (e.g., as soon as a user input corresponding to the first user input is received, display of overlay 648 is ceased).

In FIG. 6P, electronic device 600 has also received (1) second user input corresponding to movement of focus indicator 608 from within overlay 648 to a location corresponding to a graphical representation of a radio button and (2) selection of the graphical representation of the radio button. Such selection causes both the graphical representation and the radio button to change to an active state (depicted by a dot within the graphical representation and a dot within the radio button). In some examples, the text-zoom operation maintains the element highlight around radio button 644a during movement of focus indicator 608 while in the locked mode.

FIG. 6Q depicts electronic device 600 displaying overlay 650 via touch-sensitive display device 602 at an seventeenth time after the sixteenth time. In FIG. 6Q, electronic device 600 has returned to an unlocked mode, for example by receiving user input corresponding to a transition to an unlocked mode. In the unlocked mode, content is enlarged based on where focus indicator 608 is located, and overlay 648 is not maintained during movement of focus indicator 608.

In FIG. 6Q, electronic device 600 has received user input corresponding to movement of focus indicator 608 to box 644c. When focus indicator 608 is at a location corresponding to box 644c and electronic device 600 is in an enlarging mode (e.g., holding a modifier key or locking into the enlarging mode using a locking user action, such as a key to transition into the enlarging mode until the key is activated again), the text-zoom operation causes electronic device 600 to display overlay 650 with a representation of box 644c at a location below and left justified to box 644c. The representation includes a textual description of box 644c (e.g., “AUTOMATICALLY ADJUST BRIGHTNESS”) at a font size defined in options discussed above.

The representation further includes a graphical representation of a checkbox, to correspond to the box included with box 644c. The graphical representation of the checkbox is larger than and depicted as being active to match the box included with box 644c. This is an example of an item that is enlarged as a different graphical representation than included in the non-enlarged content. In particular, box 644c includes a box with an “X” inside while the graphical representation of the checkbox includes a box with a checkmark inside. In some examples, the difference in representations is based on which assets the text-zoom operation has access (e.g., the text-zoom operation might have access to a box with a checkmark inside but not a box with an “X” inside).

In some examples, in addition to causing overlay 648 to be displayed, the text-zoom operation also causes an element highlight to be displayed around radio button 644c to indicate to a user that radio button 644c is being enlarged, similar to as discussed above.

FIGS. 6R-6Z depicts how the text-zoom operation performs when used with editable content, according to some examples described herein. In particular, instead of enlarging content where a focus indicator is located such that the enlarged content changes as the focus indicator moves, the text-zoom operation enlarges content where a focus indicator is located when a modifier key is pressed and then allows a user to interact with the enlarged content when used with editable content (e.g., the enlarged content does not change and the overlay does not cease to be displayed when the focus indicator is moved (e.g., the overlay is maintained until the modifier key is pressed again)).

FIG. 6R depicts electronic device 600 displaying text editing user interface 652 on top of desktop user interface 604 via touch-sensitive display device 602 at an eighteenth time after the seventeenth time. Text editing user interface 652 allows a user to edit text. In some examples, one or more user inputs are received to reach text editing user interface 652. For example, text editing user interface 652 can be displayed in response to electronic device 600 receiving user input corresponding to selection of icon 606b.

As depicted in FIG. 6R, text editing user interface 652 includes three paragraphs of text (e.g., first paragraph 654, second paragraph 656, and third paragraph 658). Third paragraph 658 is only partially visible as depicted in FIG. 6R, with the rest of third paragraph 658 not included in a visible portion of text editing user interface 652.

FIG. 6S depicts electronic device 600 displaying text editing user interface 652 via touch-sensitive display device 602 at a nineteenth time after the eighteenth time. In FIG. 6S, electronic device 600 is displaying overlay 660. In some examples, overlay 660 is displayed in response to electronic device 600 being in an enlarging mode (e.g., holding a modifier key or locking into the enlarging mode using a locking user action, such as a key to transition into the enlarging mode until the key is activated again) and electronic device 600 receiving user input causing focus indicator 608 to be at a location corresponding to first paragraph 654.

Overlay 660 includes a representation of first paragraph 654 at a location below and left justified to first paragraph 654. The representation includes enlarged insertion marker 660a (corresponding to insertion marker 654a) and enlarged text 660b (corresponding to text 654b). In some examples, enlarged insertion marker 660a is larger in size than insertion marker 654a and enlarged text 660b is larger in size than text 654b. In some examples, enlarged insertion marker 660a has the same functionality as insertion marker 654a (e.g., enlarged insertion marker 660a blinks similarly to insertion marker 654a). This is an example of text and an insertion marker being enlarged.

In some examples, in addition to causing overlay 660 to be displayed, the text-zoom operation also causes an element highlight to be displayed around first paragraph 654 to indicate to a user that first paragraph 654 is being enlarged, similar to as discussed above.

FIG. 6T depicts an example of configuring overlay 660 to have a different background and a different font than content being enlarged via overlay 660. For example: text 660c has a different font than first paragraph 654; text 660c has a different font than text 660b; and the background of overlay 660 is depicted in FIG. 6T as being different than the background of first paragraph 654. While not depicted, in some examples, the size and/or color of the text in overlay 660 can also be configured.

In some examples, when a user has configured an option (e.g., background, font color, border, etc.) to be a particular color (e.g., purple) and content that is being enlarged includes at least a portion that is within a threshold contrast of the particular color (e.g., font color of text is purple when the user has configured the background to be purple), the text-zoom operation modifies either the configured color or the enlarged content to create a larger contrast between the configured color and the enlarged content. In some examples, the text-zoom operation modifies a color by maintaining the same hue but increasing contrast (in some examples, contrast is determined using a color comparing algorithm that compares one color to another color). In some examples, when the contrast cannot be increased to a point that exceeds the threshold contrast, the text-zoom operation modifies non-user configured colors first and configured colors second such that the modified color is no longer the same hue as before modifying. In other examples, when the contrast cannot be increased to a point that exceeds the threshold, the text-zoom operation modifies configured colors first and non-configured colors second. In some examples, the text-zoom operation will modify either the configured color or the non-configured color depending on which has more head room to be modified. For example, the background might be black or close to black while text is gray. In such an example, the text is modified instead of the background because the text has more headroom (e.g., gray has more ability to change within the hue than black, referred to as more head room).

FIG. 6U depicts electronic device 600 displaying text editing user interface 652 via touch-sensitive display device 602 at a twentieth time after the nineteenth time. In FIG. 6U, electronic device 600 has received user input to insert the word “HELLO” where insertion marker 660 was located in FIG. 6S (e.g., a user has typed the word “HELLO” using a keyboard). In response to the user input, the word “HELLO” has been inserted before text 660b. FIG. 6U illustrates that, when the word “HELLO” is inserted into overlay 660, the word “HELLO” is also inserted in first paragraph 654 before text 654b (see text 654c). Such insertion of the word “HELLO” in first paragraph 654 can occur concurrently with, before, or after insertion of the word “HELLO” in overlay 660, without any further user input.

FIG. 6V depicts electronic device 600 displaying text editing user interface 652 via touch-sensitive display device 602 at a twenty-first time after the twentieth time. In FIG. 6V, electronic device 600 has received user input to highlight the word “HELLO” (e.g., a user has double tapped on the word “HELLO” via touch-sensitive display device 602). In response to the user input, the word “HELLO” has been selected (e.g., highlighted to be visually distinct from other characters). FIG. 6V illustrates that, when the word “HELLO” is selected in overlay 660, the word “HELLO” is also selected in first paragraph 654. Such selection of the word “HELLO” in first paragraph 654 can occur concurrently with, before, or after selection of the word “HELLO” in overlay 660, without any further user input. In some examples, when content is selected (e.g., visually distinguished, sometimes referred to as highlighted) before an overlay is displayed, the overlay will have enlarged content corresponding to the content selected when enlarging the selected content in the overlay. Other forms of visually distinguishing content will also be propagated to the overlay, including strikethroughs, underlines, and the like.

FIG. 6W depicts electronic device 600 displaying text editing user interface 652 via touch-sensitive display device 602 at a twenty-second time after the twenty-first time. In FIG. 6W, electronic device 600 has received user input to delete the word “HELLO” (e.g., a user has selected a delete key via touch-sensitive display device 602). In response to the user input, the word “HELLO” has been deleted from overlay 660. FIG. 6W illustrates that, when the word “HELLO” is deleted in overlay 660, the word “HELLO” is also deleted in first paragraph 654. Such deletion of the word “HELLO” in first paragraph 654 can occur concurrently with, before, or after deletion of the word “HELLO” in overlay 660, without any further user input.

FIG. 6X depicts electronic device 600 displaying text editing user interface 652 via touch-sensitive display device 602 at a twenty-third time after the twenty-second time. In FIG. 6X, electronic device 600 has received user input to move insertion marker 654a to a new paragraph (e.g., down a single line). In response to the user input, electronic device 600 forgoes display of overlay 660 and displays overlay 664, which corresponds to second paragraph 656. Such a result is due to insertion marker 654a being located on a last line of overlay 660. In some examples, focus indicator 608 maintains its location corresponding to first paragraph 654 and not a location corresponding to second paragraph 656 even though overlay 664 corresponds to second paragraph 656 (as depicted in FIG. 6X).

Overlay 664 is displayed at a location below and justified to the left side of second paragraph 656 such that both second paragraph 656 and overlay 664 can be viewed concurrently. Overlay 664 includes content corresponding to second paragraph 656 (e.g., an enlarged version of content in second paragraph 656).

FIG. 6X depicts that overlay 664 includes scroll bar 664c. In some examples, scroll bars are included in overlays when content to be displayed in an overlay is more than can be displayed in a predefined number of lines for the overlay. For example, when an overlay is configured to have 3 lines and content to be displayed in overlay requires more than 3 lines, the overlay would include a scroll bar so that a user can scroll the overlay to view content not initially visible in the overlay. Scrolling of the overlay can occur in a number of ways, including a gesture via touch-sensitive display device 602 (e.g., a two-finger swipe in a direction to scroll), a key press to move an insertion marker (e.g., insertion marker 664a) (e.g., a press of a down key while the overlay is being displayed), or use of a scroll bar (e.g., scroll bar 664c) with a focus indicator (e.g., focus indicator 608). In some examples, scrolling within overlay 664 occurs until reaching an end of content within overlay 664, at which time scrolling would affect content within text editing user interface 652 (e.g., text editing user interface 652 would scroll until a new overlay may be displayed). In some examples, one gesture to scroll overlay 664 would not scroll text editing user interface 652. In such examples, another gesture is required to scroll text editing user interface 652 after reaching an end of overlay 664 with an initial scroll (e.g., an additional scroll gesture).

In some examples, line lengths in overlays do not match line lengths in content being enlarged in the overlays (e.g., 2 lines of content can be enlarged to be 5 lines of content, as depicted in FIGS. 6X-6Y). In such examples, movement of an insertion marker in an overlay might not be the same as in the content being enlarged. For example, user input corresponding to move an insertion marker down one line in an overlay might not cause an insertion marker in content being enlarged to go down one line. Instead, the insertion marker in the overlay is moved down one line and the insertion marker in content being enlarged is moved to a location corresponding to a location where the insertion marker is in the overlay. For example, FIG. 6Y depicts insertion marker 664a at a beginning of a final line of overlay 664; however, insertion marker 654a is not at a beginning of a final line of second paragraph 656. Instead, insertion marker 654a is placed at a location in second paragraph 656 to correspond to a location that insertion marker 664a is located in overlay 664. For example, insertion marker 664a is between the word “viverra” and the word “tellus” in overlay 664 while insertion marker 654a is between the word “viverra” and the word “tellus” in second paragraph 656.

In some examples, when an insertion marker in a first overlay is moved down a line in first content (e.g., content within the first overlay), causing a second overlay to be displayed with second content, an insertion marker is placed in the second content at a location corresponding to where the insertion marker in the first overlay would be if moved down a line and the second content was included with the first content. For example, if the insertion marker in the first overlay is located half way in a last line of the first content before moving down, the insertion marker in the second overlay would be placed half way in a first line of the second content (e.g., the enlarged content).

FIG. 6Z depicts electronic device 600 displaying text editing user interface 652 via touch-sensitive display device 602 at a twenty-fourth time after the twenty-third time. In FIG. 6Z, electronic device 600 has received user input to move insertion marker 654a to a new paragraph (e.g., down a single line). In response to the user input, electronic device 600 forgoes display of overlay 664 and displays overlay 666, which corresponds to third paragraph 658. FIG. 6Z also depicts that text editing user interface 652 (e.g., first paragraph 654, second paragraph 656, and third paragraph 658) have scrolled to reveal all of third paragraph 658. Such scrolling can occur in response to user input that causes an overlay to move from a paragraph that is visible within text editing user interface 652 (e.g., second paragraph 656) to a paragraph that is not entirely visible within text editing user interface 652 (e.g., third paragraph 658).

Overlay 666 is displayed at a location below and justified to the left side of third paragraph 658 such that both third paragraph 658 and overlay 666 can be viewed concurrently. Overlay 666 includes content corresponding to third paragraph 658 (e.g., an enlarged version of content in third paragraph 658). As depicted in FIG. 6Z, content 666b includes a Uniform Resource Locator (URL) (e.g., URL 666c) and focus indicator 608 is at a location corresponding to URL 666c. In some examples, selection of URL 666c from within overlay 666 causes a browser to navigate to URL 666c (in some examples, a browser and/or tab in the browser is opened and URL 666c is inserted into an address bar of the browser to be navigated to using the browser, as depicted in FIG. 6AA).

FIG. 6AA depicts electronic device 600 displaying browser 668 via touch-sensitive display device 602 at a twenty-fifth time after the twenty-fourth time. In some examples, browser 668 is displayed in response to selection of a URL (e.g., pharetra.com), as depicted in FIG. 6Z. Browser 668 includes a webpage navigated to using the URL. The webpage includes title 668a and content 668b.

FIG. 6AB depicts electronic device 600 displaying overlay 670 via touch-sensitive display device 602 at a twenty-sixth time after the twenty-fifth time. Similar to as described above for other figures, in FIG. 6F, electronic device 600 has received user input corresponding to movement of focus indicator 608 to title 668a. The movement causes focus indicator 608 to be at a location corresponding to title 668a. When focus indicator 608 is at the location and electronic device 600 is in an enlarging mode (e.g., holding a modifier key or locking into the enlarging mode using a locking user action, such as a key to transition into the enlarging mode until the key is activated again), the text-zoom operation causes electronic device 600 to display overlay 670 with a representation of title 668a at a location below and left justified to title 668a. The representation is a textual description of title 668a at a font size defined in options discussed above. This is an example of text that is enlarged as text. In some example, when the size of the text to be enlarged is within a threshold size from a predefined size for enlarged text, an overlay is not displayed when focus indicator 608 is at a location corresponding to the text and electronic device 600 is in an enlarging mode (e.g., holding a modifier key or locking into the enlarging mode using a locking user action, such as a key to transition into the enlarging mode until the key is activated again).

In some examples, in addition to causing overlay 670 to be displayed, the text-zoom operation also causes an element highlight to be displayed around title 668a to indicate to a user that title 668a is being enlarged, similar to as discussed above.

FIG. 6AC depicts electronic device 600 displaying overlay 672 via touch-sensitive display device 602 at a twenty-seventh time after the twenty-sixth time. In FIG. 6AC, electronic device 600 has received user input corresponding to movement of focus indicator 608 to paragraph 668b. When focus indicator 608 is at a location corresponding to paragraph 668b and electronic device 600 is receiving user input corresponding to a modifier key (e.g., options key as discussed above), the text-zoom operation causes electronic device 600 to display overlay 672 with a representation of paragraph 668b at a location above and right justified to paragraph 668b. In some examples, overlay 672 is above and right justified to paragraph 668b because there is not enough area for overlay 672 to be displayed below and left justified to paragraph 668b.

Overlay 672 further includes scroll bar 672b for scrolling within overlay 672. FIG. AD depicts scrolling of overlay 672, where overlay 672 is scrolled and browser 668 is not scrolled. In FIG. AD, the scrolling can occur in response to a user maintaining focus indicator 608 at a location corresponding to paragraph 668b while receiving user input indicating to scroll (e.g., a two finger gesture in a direction).

FIGS. 7A-7C is a flow diagram illustrating a method for increasing the visibility of user interface elements using an electronic device in accordance with some embodiments. Method 700 is performed at a device (e.g., 100, 300, 500, 600) with a display device. Some operations in method 700 are, optionally, combined, the orders of some operations are, optionally, changed, and some operations are, optionally, omitted.

As described below, method 700 provides an intuitive way for increasing the visibility of user interface elements. The method reduces the cognitive burden on a user for increasing the visibility of user interface elements, thereby creating a more efficient human-machine interface. For battery-operated computing devices, enabling a user to utilize user interface elements faster and more efficiently conserves power and increases the time between battery charges.

The electronic device (e.g., 600) displays (702), via the display device, a first version (e.g., a non-enlarged version) of a first content (e.g., text and/or an icon) (e.g., 606c, 636, 654).

While displaying the first version of the first content, the electronic device displays (704), via the display device, a focus indicator (e.g., 608) (e.g., a mouse cursor, pointer, or an insertion marker) at a first location that does not correspond (e.g., not directed, not proximate to, unassociated, or unrelated to) to the first version of the first content.

The electronic device receives (706) a first input (e.g., moving a mouse cursor using a mouse or tapping a finger on the first content) (e.g., FIG. 6E to 6F).

In response to receiving the first input, the electronic device moves (708) the focus indicator from the first location to a second location (e.g., the first content is included in the second location) (e.g., FIGS. 6E to 6F).

In accordance with the second location corresponding to the first version of the first content and a set of second version display criteria being met, the electronic device concurrently displays (710), via the display device at least a portion of the first version of the first content (712) and a second version (e.g., 628a, 628b, 628c, 638, 660a) (e.g., an enlarged version) of the first content (714), whereby the second version differs from the first version in a visual characteristic other than size (e.g., color, text when the first version is an icon, or different asset generated prior to receiving the user input). In some embodiments, the second version is included in an overlay (e.g., 628, 638, 660) on top of content including the first version.

In some embodiments, the second version display criteria includes a criterion that is met when a second input (e.g., actuation of a modifier key), distinct from the first input, is received prior to or concurrently with the first input. In some embodiments, the second input is received prior to the first input (e.g., the second input is input that toggles a mode (e.g., a second version active mode) of the electronic device)).

In some embodiments, the second input is received concurrently with the first input (716). In some embodiments, while displaying the second version of the first content, the electronic device detects (718) that the second user input has ceased (e.g., a modifier key is no longer actuated). In some embodiments, in response to detecting that the second user input has ceased, the electronic device ceases (720) to display the second version of the first content.

Concurrently displaying at least a portion of the first version of the first content and a second version of the first content, where the first and second versions differ in a visual characteristic other than size, allows a user to interact with content that is not simply resized, but rather re-rendered and/or otherwise emphasized. By way of example, instead of merely displaying scaled content, the electronic device may display content having different aspect ratio, colors, icons, text, and so forth. As a result, the electronic device allows a user to efficiently and intuitively interact with content displayed by the electronic device. In turn, this decreases the number of inputs and amount of time needed for the user to operate the electronic device (e.g., by helping the user provide proper inputs and reducing user mistakes when operating/interacting with the device), which, additionally, reduces power usage and improves battery life of the device.

In some embodiments, the first version includes (e.g., consists of) a first icon (e.g., 606b, 606c). In some embodiments, the second version includes (e.g., consists of) text (e.g., 628b) that corresponds to (e.g., describes) the first icon. In some embodiments, the first version includes (e.g., consists of) a second icon. In some embodiments, the second version includes a third icon (e.g., 628a) corresponding to the second icon and text that corresponds to (e.g., describes) the second icon. In embodiments, the first version includes a fourth icon. In some embodiments, the second version includes a fifth icon different from the first icon in a visual characteristic other than size. In some embodiments, the first icon corresponds to a first asset and the second icon corresponds to a second asset different from the first asset. In some embodiments, the first version is in a first state (e.g., a badge, “selected,” “enabled,” “disabled,” “highlighted,” or strikethrough). In some embodiments, the second version includes a graphical representation (e.g., an icon or text) of the first state.

Including text in the second version that corresponds to an icon of the first version allows a user to efficiently and intuitively identify the first content, for instance, in scenarios in which the user does not identify the first content based on the icon. As a result, the electronic device allows a user to efficiently and intuitively interact with content displayed by the electronic device. In turn, this decreases the number of inputs and amount of time needed for the user to operate the electronic device (e.g., by helping the user provide proper inputs and reducing user mistakes when operating/interacting with the device), which, additionally, reduces power usage and improves battery life of the device.

In some embodiments, the visual characteristic is a user-configurable visual characteristic (e.g., configurable through one or more setting user interfaces associated with the second version) (e.g., interface 612). In some embodiments, the first version includes an abbreviated version (e.g., “Comp.”) (e.g., text on a calendar event where there is not enough room for all text corresponding to the calendar event) of second content. In some embodiments, the second version includes a non-abbreviated version (e.g., “Computer”) of the second content.

In some embodiments, as a part of displaying the first version of the first content, the electronic device displays a first version of a second content (e.g., second text, a different icon) and a first version of a third content. In some embodiments, while displaying the second version of the first content, the electronic device visually distinguishes (e.g., by displaying an element highlight around the first version of the first content) the first version of the first content from the first version of the second content and the first version of the third content (e.g., FIG. 6S).

In accordance with the second location not corresponding to the first version of the first content, the electronic device forgoes display of the second version of the first content.

In some embodiments, in accordance with (722) a determination that there is enough space for the second version to be displayed at a third location (e.g., below) adjacent to the first content, the second version is displayed at the third location (e.g., corresponding to below the first content) and aligned to a first side (e.g., a left side) of the first content (e.g. FIG. 6F). In some embodiments, in accordance with (724) a determination that there is not enough space for the second version to be displayed at the third location adjacent to the first content, the second version is displayed at a fourth location (e.g., corresponding to above the first content) (e.g., FIG. 6G). In some embodiments, the fourth location is different from the third location.

In some embodiments, a background of the second version is user-defined color (e.g., defined through one or more setting user interfaces associated with the second version; as seen in FIG. 6G). In some embodiments, as a part of displaying the second version and in accordance with a determination that a color of the first content (e.g., a color of text of the first content or a color of an icon of the first content) is not within a color threshold of the user-defined color (e.g., has a hue that is within a predefined degree of similarity to the user-defined color), the electronic device displays a foreground (e.g., portion other than the background (e.g., text, icons)) of the second version using the color of the first content. In some embodiments, as a part of displaying the second version and in accordance with a determination that a color of the first content is within a color threshold of the user-defined color, the device displays the foreground of the second version using a color (e.g., a system selected color) that is not within the color threshold of the user-defined color.

In some embodiments, the second version includes a uniform resource identifier (e.g., 666c) (URI) (e.g., uniform resource locator (URL) or uniform resource name (URM)). In some embodiments, the electronic device receives third input corresponding to selection of the URI (e.g., a touch gesture on the URI; as seen in FIG. 6Z). In some embodiments, in response to the third input, the electronic device displays content (e.g., 668a, 668b) accessed based on the URI (e.g., opening a browser and navigating to a uniform resource locator (URL)).

Note that details of the processes described above with respect to method 700 (e.g., FIGS. 7A-7C) are also applicable in an analogous manner to the methods described below/above. For example, method 800 optionally includes one or more of the characteristics of the various methods described above with reference to method 700. For brevity, these details are not repeated below.

FIGS. 8A-8C is a flow diagram illustrating a method for increasing the visibility of user interface elements using an electronic device in accordance with some embodiments. Method 800 is performed at a device (e.g., 100, 300, 500, 600) display device and one or more input devices, including a pointing device. Some operations in method 800 are, optionally, combined, the orders of some operations are, optionally, changed, and some operations are, optionally, omitted.

As described below, method 800 provides an intuitive way for increasing the visibility of user interface elements. The method reduces the cognitive burden on a user for increasing the visibility of user interface elements, thereby creating a more efficient human-machine interface. For battery-operated computing devices, enabling a user to utilize user interface elements faster and more efficiently conserves power and increases the time between battery charges.

The electronic device (e.g., 600) concurrently displays (802), via the display device: a first visible portion (e.g., an on-display portion) of a first user interface (e.g., 652) (804) (e.g., an application window (e.g., a web browser, a word processor)) that includes a plurality of content segments, including a first content segment (e.g., 654, 656) (e.g., a block of text (e.g., a paragraph), an image), where the first visible portion includes the first content segment; and a focus indicator (e.g., 608) (806) (e.g., a cursor, a text insertion pointer) that is moveable via the pointing device.

In some embodiments, the first content segment includes editable text (e.g., text of 654, text of 656). In some embodiments, the focus indicator is a text insertion marker (e.g., 654a).

While the focus indicator is at a first position corresponding to the first content segment and while the first user interface is configured to receive indicator-based inputs (e.g., the first user interface is an active window or in-focus window and indicator-based inputs (e.g., mouse clicks; text insertion) affect the first user interface), the electronic device receives (808) a first set of one or more inputs (e.g., actuation of one or more modifier keys (e.g., ctrl, alt, shift+alt)) (e.g., FIG. 6R).

In response to (810) receiving the first set of one or more inputs, the electronic device displays (812), via the display device, a second user interface (e.g., 664) (e.g., a pop-up window (e.g., an operating system generated window)) over at least a first sub-portion of the first visible portion of the first user interface (e.g., a portion of the user interface that includes at least a portion of the first content segment). The second user interface includes a first visible content (e.g., 664b) (e.g., on-screen content) that corresponds to at least a portion of the first content segment (e.g., content that is an enlargement of at least a portion of the first content segment; content that is derived from at least a portion of the first content segment).

In some embodiments, the first set of one or more inputs includes an input (e.g., actuation of a second modifier key (e.g., ctrl, alt, shift+alt)) corresponding to a request to configure the second user interface to receive indicator-based inputs. In some embodiments, actuation of a first modifier key, while the focus indicator corresponds to the first content segment, causes the second user interface to be displayed without configuring the second user interface to receive indicator-based inputs (e.g., the first user interface remains configured to receive indicator-based inputs). The second user interface is configured to receive indicator-based inputs only after a second modifier key is actuated (e.g., while the first modifier key remains actuated (e.g., FIG. 6S).

In response to (810) receiving the first set of one or more inputs, the electronic device maintains (814) display of at least a second sub-portion of the first visible portion of the first user interface (e.g., a portion of the user interface that includes at least a portion of the first content segment; a portion of the user interface that includes at least a portion of a second content segment of the plurality of content segments) (e.g., FIG. 6S).

In response to (810) receiving the first set of one or more inputs, the electronic device configures (816) the second user interface to receive indicator-based inputs (e.g., and configuring the first user interface to no longer receive indicator-based inputs) (e.g., 6U).

While the second user interface is configured to receive indicator-based inputs, the electronic device receives (818) a second set of one or more inputs (e.g., interaction with a scrollbar of the second user interface, actuation of an arrow key) corresponding to a request to scroll content (e.g., FIG. 6W).

In some embodiments the (e.g., first or second) set of one or more inputs is a single input (e.g., actuation of a single modifier key that causes both display of the second user interface and configuring the second user interface to receive indicator-based inputs).

In some embodiments, the first visible content of the second user interface includes a first graphical control element (e.g., a checkbox, a radio element) having a plurality of predefined states (e.g., checked, unchecked) and the first visible portion of the first user interface includes a second graphical control element having a state that matches a state of the first graphical control element (e.g., FIG. 60). In some embodiments, while the first graphical control element has a first state (e.g., unchecked) of the plurality of predefined states and the second graphical control element has the first state, the electronic device detects a third set of one or more inputs (e.g., including an input that causes movement of the focus indicator) that includes an input (e.g., a left-click while the focus indicator is at a location corresponding to the first graphical element and while the second user interface is configured to receive indicator-based inputs) corresponding to the first graphical control element (e.g., FIG. 6P). In some embodiments, in response to detecting the third set of one or more inputs, the electronic device changes the state of the first graphical element from the first state to a second state of the plurality of predefined states (e.g., changing a checkbox from unchecked to checked). In some embodiments, in response to detecting the third set of one or more inputs, the electronic device changes the state of the second graphical element from the first state to the second state (e.g., FIG. 6P).

In response to (820) receiving the second set of one or more inputs and in accordance with a determination that first scrolling criteria are met (e.g., criteria that includes a criterion that is met when the first visible content corresponds to an internal portion of the first content segment), the electronic device scrolls (822) the second user interface by replacing the first visible content (e.g., 664b as depicted in FIG. 6X) with a second visible content (e.g., 664b as depicted in FIG. 6Y) (e.g., visible content that includes a portion of the first visible content; visible content that includes no portion of the first visible content). In some embodiments, the electronic device also forgoes scrolling the first user interface (e.g., maintaining display of the first visible portion in the first user interface).

In response to (820) receiving the second set of one or more inputs and in accordance with (824) a determination that second scrolling criteria are met (e.g., criteria that includes a criterion that is met when the first visible content corresponds to a terminal portion of the first content segment), the electronic device: scrolls (826) the second user interface (e.g., 652) by replacing the first visible content (e.g., 664b as depicted in FIG. 6X) with a third visible content (e.g., 664b as depicted in 6Z) (e.g., content different than the second visible content); and scrolls (828) the first user interface by replacing the first visible portion with a second visible portion (e.g., a visible portion that includes a portion of the first visible portion; a visible portion that includes no portion of the first visible portion; a visible portion that includes content that is also included in the third visible content). In some embodiments, the second visible portion includes a third content segment that was not included in the first visible portion.

Scrolling a second user interface when first scrolling criteria are met, and scrolling the second user interface and a first user interface when second scrolling criteria are met ensures that the first user interface is scrolled only when newly displayed content of the second user interface is not yet displayed in a visible portion of the first user interface. As a result, the electronic device mitigates unnecessary scrolling of the first user interface, allowing a user to better view and/or interact with each of the first user interface and second interface, which in turn decreases the number of inputs and amount of time needed for the user to operate the electronic device (e.g., by helping the user provide proper inputs and reducing user mistakes when operating/interacting with the device), which, additionally, reduces power usage and improves battery life of the device.

In some embodiments, the second scrolling criteria are met when the first visible content corresponds to a terminal portion of the first content segment (e.g., FIG. 6Z). In some embodiments, the second scrolling criteria includes a criterion that is met when the second set of one or more inputs includes a first input received (e.g., initially received, the first input is not a non-initial portion of a sustained input (e.g., sustained actuation of an arrow key)) while the first visible content of the second user interface corresponds to a terminal portion (e.g., the beginning or end) of the first content segment. In some embodiments, the second scrolling criteria are not met when the second set of one or more inputs are received while the first visible content of the second user interface does not correspond to at terminal portion (e.g., the beginning or end) of the first content segment.

In some embodiments, while the second user interface is configured to receive indicator-based inputs, the electronic device receives (830) a fourth set of one or more inputs (e.g., a selection input using a mouse). In some embodiments, in response to (832) the fourth set of one or more inputs, the electronic device performs (834) a first operation (e.g., inserting text, cutting, copying, selecting) on the first visible content of the second user interface that includes modifying the first visible content (e.g., FIG. 6V). In some embodiments, in response to (832) the fourth set of one or more inputs, the electronic device performs (836) (e.g., concurrently, simultaneously) the first operation on the first content segment, including modifying the first content segment. In some embodiments, operations performed on the content in the second user interface are mirrored (e.g., matched) in the corresponding content in the first user interface. In some embodiments, the first operation is a selection of a third sub-portion of the first visible content of the second user interface. In some embodiments, the selection causes the third sub-portion to be visually distinguished (e.g., highlighted).

Performing the first operation on the first visible content and the first operation on the first content segment in response to a set of inputs (e.g., fourth set of inputs) allows a user to intuitively and efficiently view and/or interact with the first visible content and the first content segment simultaneously. As an example, a user need not provide separate inputs to edit each of the first visible content and the first content segment in a same manner, thus decreasing the number of inputs and amount of time needed for the user to operate the electronic device (e.g., by helping the user provide proper inputs and reducing user mistakes when operating/interacting with the device), which, additionally, reduces power usage and improves battery life of the device.

In some embodiments, the first content segment (e.g., a block of text in the first user interface) includes a sequence of characters (e.g., ordered characters that form a script) that span a first number of lines (e.g., 3 lines). In some embodiments, the focus indicator is a first text insertion marker (e.g., 654a) positioned at a first position in the sequence of characters that is between first and second characters of the sequence of characters (e.g., a positon between the 10th and 11th , on the second line of three lines, in a sequence of 30 characters). In some embodiments, the first visible content (e.g., on-screen content) includes a subsequence (e.g., less than the entire sequence, the entire sequence) of the sequence of characters that span a second number of lines, different from the first number lines, (e.g., 2 lines, a number of lines that is different from the first number of lines) and that includes the first and second characters. In some embodiments, the electronic device displays a second text insertion marker e.g., (664a) (e.g., a second focus indicator) at a first position in the subsequence of the sequence of characters that is between the first and second characters of the sequence of characters (e.g., corresponds to (e.g., matches) the first position in the sequence of characters (e.g., the insertion marker in the second user interface is at the same position in the text as the first insertion marker is in matching text of the first user interface)). In some embodiments, while displaying the second text insertion marker at the first position in the subsequence of the sequence of characters, the electronic device detects a fifth set of one or more inputs. In some embodiments, in response to detecting the fifth set of one or more inputs (e.g., actuation of an arrow key), the electronic device moves the second text insertion marker to a second position in the subsequence of the sequence of characters that is between third and fourth characters of the sequence of characters and moves the first text insertion marker to a second position in the sequence of characters that is between the third and fourth characters of the sequence of characters. In some embodiments, movement of the insertion marker in the second user interface causes a matching movement of the insertion marker in the first user interface so that the two insertion markers are both positioned at the same position (e.g., between the same characters) in the matching texts.

In some embodiments, the first content segment is associated with a drop-down menu that includes a plurality of selectable options that are associated with the first content segment (e.g., are updated based on text inputted in a text entry field of the first content segment), the plurality of selectable options including a first selectable option (e.g., 636a) (e.g., a first option in the drop-down menu) that is visibly distinguished (e.g., currently selected). In some embodiments, while the first visible content of second user interface (e.g., 604) includes the first selectable option and while the second user interface is displayed adjacent to the first selectable option in the first content segment and while the focus indicator remains at the first position corresponding to the first content segment, the electronic device detects a sixth set of one or more inputs (e.g., actuation of an arrow key). In some embodiments, the first content segment includes a text entry field (e.g., 636). In some embodiments, in response to detecting the sixth set of one or more inputs, the electronic device ceases to visually distinguish the first selectable option. In some embodiments, in response to detecting the sixth set of one or more inputs, the electronic device visually distinguishes (e.g., selecting) a second selectable option (e.g., 636e) (e.g., a second option, below the first option, in the drop-down menu) of the plurality of selectable options. In some embodiments, in response to detecting the sixth set of one or more inputs, the electronic device replaces the first visible content of the second user interface with a fourth visible content (e.g., 642) that includes the second selectable option. In some embodiments, the electronic device displays the second user interface adjacent to the second selectable option in the first content segment.

Note that details of the processes described above with respect to method 800 (e.g., FIGS. 8A-8C) are also applicable in an analogous manner to the methods described below/above. For example, method 800 optionally includes one or more of the characteristics of the various methods described above with reference to method 700. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery to users of enlarged content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to have precise control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of content enlarging services, the present technology can be configured to allow users to select to “opt in” or “opt out” of participation in the collection of personal information data during registration for services or anytime thereafter. In another example, users can select not to provide personal data for targeted content enlarging services. In yet another example, users can select to limit the length of time personal data is maintained or entirely prohibit the development of a baseline profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content enlarging services, or publicly available information.

What is claimed is:

1. An electronic device, comprising:
a display device;
one or more processors; and
memory storing one or more programs configured to be executed by the one or more processors, the one or more programs including instructions for:
displaying, via the display device, a first version of a first content;
while displaying the first version of the first content, displaying, via the display device, a focus indicator at a first location that does not correspond to the first version of the first content;
receiving a first input;
in response to receiving the first input, moving the focus indicator from the first location to a second location;
in accordance with the second location corresponding to the first version of the first content and a set of second version display criteria being met, concurrently displaying, via the display device:
at least a portion of the first version of the first content; and
a second version of the first content, wherein the second version differs from the first version in a visual characteristic other than size; and
in accordance with the second location not corresponding to the first version of the first content, forgoing display of the second version of the first content.

2. The electronic device of claim 1, wherein the set of second version display criteria includes a criterion that is met when a second input, distinct from the first input, is received prior to or concurrently with the first input.

3. The electronic device of claim 2, wherein the second input is received concurrently with the first input, the one or more programs further including instructions for:
while displaying the second version of the first content, detecting that the second input has ceased; and
in response to detecting that the second input has ceased, ceasing to display the second version of the first content.

4. The electronic device of claim 2, wherein the second input is received prior to the first input.

5. The electronic device of claim 1, wherein the first version includes a first icon, and wherein the second version includes text that corresponds to the first icon.

6. The electronic device of claim 1, wherein the first version includes a second icon, and wherein the second version includes a third icon corresponding to the second icon and text that corresponds to the second icon.

7. The electronic device of claim 1, wherein the first version includes a fourth icon, and wherein the second version includes a fifth icon different from the fourth icon in a visual characteristic other than size .

8. The electronic device of claim 1, wherein the visual characteristic is a user-configurable visual characteristic.

9. The electronic device of claim 1, wherein the first version includes an abbreviated version of second content, and wherein the second version includes a non-abbreviated version of the second content.

10. The electronic device of claim 1, wherein displaying the first version of the first content includes displaying a first version of a second content and a first version of a third content, the one or more programs further including instructions for:
while displaying the second version of the first content, visually distinguishing the first version of the first content from the first version of the second content and the first version of the third content.

11. The electronic device of claim 1, wherein the second version includes a uniform resource identifier (URI), the one or more programs further including instructions for:
receiving third input corresponding to selection of the URI; and
in response to the third input, displaying content accessed based on the URI.

12. The electronic device of claim 1, wherein the first version is in a first state, and wherein the second version includes a graphical representation of the first state.

13. The electronic device of claim 1, wherein:
in accordance with a determination that there is enough space for the second version to be displayed at a third location adjacent to the first content, the second version is displayed at the third location and aligned to a first side of the first content, and
in accordance with a determination that there is not enough space for the second version to be displayed at the third location adjacent to the first content, the second version is displayed at a fourth location, wherein the fourth location is different from the third location.

14. The electronic device of claim 1, wherein a background of the second version is user-defined color and wherein displaying the second version includes:
in accordance with a determination that a color of the first content is not within a color threshold of the user-defined color, displaying a foreground of the second version using the color of the first content; and
in accordance with a determination that a color of the first content is within a color threshold of the user-defined color, displaying the foreground of the second version using a color that is not within the color threshold of the user-defined color.

15. A non-transitory computer-readable storage medium storing one or more programs configured to be executed by one or more processors of an electronic device with a display device, the one or more programs including instructions for:
displaying, via the display device, a first version of a first content;
while displaying the first version of the first content, displaying, via the display device, a focus indicator at a first location that does not correspond to the first version of the first content;
receiving a first input;
in response to receiving the first input, moving the focus indicator from the first location to a second location;
in accordance with the second location corresponding to the first version of the first content and a set of second version display criteria being met, concurrently displaying, via the display device:
at least a portion of the first version of the first content; and
a second version of the first content, wherein the second version differs from the first version in a visual characteristic other than size; and
in accordance with the second location not corresponding to the first version of the first content, forgoing display of the second version of the first content.

16. A method, comprising:
at an electronic device with a display device:
displaying, via the display device, a first version of a first content;
while displaying the first version of the first content, displaying, via the display device, a focus indicator at a first location that does not correspond to the first version of the first content;
receiving a first input;
in response to receiving the first input, moving the focus indicator from the first location to a second location;
in accordance with the second location corresponding to the first version of the first content and a set of second version display criteria being met, concurrently displaying, via the display device:
at least a portion of the first version of the first content; and
a second version of the first content, wherein the second version differs from the first version in a visual characteristic other than size; and
in accordance with the second location not corresponding to the first version of the first content, forgoing display of the second version of the first content.
